(19) United States
(12) Patent Application Publication
(10) Pub. No.: US 2006/0219608 A1
(43) Pub. Date: Oct. 5, 2006

(54) Connected screens for vibratory separators

(76) Inventors: Eric Scott, Conroe, TX (US); David L. Schulte JR., Willis, TX (US); Guy L. McClung III, Spring, TX (US)

Correspondence Address: Guy L. McClung, III;PMB 347, 16690 Champion Forest Drive, Spring, TX, 77379-7023, US

(21) Appl. No.: 11/366,218

(22) Filed: Mar. 2, 2006

Related U.S. Application Data
(63) Continuation-in-part of application No. 11/301,349, filed on Dec. 12, 2005.
(63) Continuation-in-part of application No. 10/359,733, filed on Feb. 4, 2003, now Pat. No. 7,063,214.
(63) Continuation-in-part of application No. 10/429,290, filed on May 2, 2003, now Pat. No. 7,040,488.

(51) Int. Cl. B07B 1/49

(52) U.S. Cl. 209/406

(57) ABSTRACT

Interconnectible screen assemblies for vibratory separators or shale shakers and methods for manipulating such screen assemblies which, in certain aspects, include a first screen assembly and a second screen assembly positioning at least a portion of the first screen assembly with respect to the second screen assembly, releasably connecting the second screen assembly to the first screen assembly, and moving the first screen assembly and the second screen assembly together.

### CROSS-REFERENCE TO RELATED APPLICATIONS

This is a continuation-in-part of U.S. patent application Ser. No. 11/301,349 filed Dec. 12, 2005; Ser. No. 10/359,733 filed Feb. 4, 2003; and Ser. No. 10/429,290 filed May 1, 2003—from all of which the present invention claims priority under the Patent Laws and all of which are incorporated fully herein for all purposes.

### BACKGROUND OF THE INVENTION

1. Field Of The Invention

The present invention is directed to screens and screen assemblies for vibratory separators and shale shakers, to screen assembly seals and holders and mounts for them, to releasably connectible screens and screen assemblies, and to methods of mounting them within and removing them from such separators and shakers.

2. Description of Related Art

The prior art discloses a variety of screen assembly mounting structures for holding screen assemblies in position. In many instances screen assemblies are positioned sequentially on or within mounting structures of a vibratory separator or shale shaker. For example, many such apparatuses have spaced apart channels into which screen assemblies are inserted one after the other and from which they are removed sequentially one at a time. Often removal of these screen assemblies can be difficult, particularly the removal of those farthest away from an insertion end of the mounting structure or fluid exit end of a support deck.

There has long been a need, recognized by the present inventors, for screen assemblies that are easily positionable on or within and removable from mounting structure within a separator or shaker. There has long been a need for such screen assemblies which do not require the individual removal of separate screen assemblies one at a time.

### BRIEF SUMMARY OF THE INVENTION

The present invention discloses, in certain aspects, a method for manipulating a first screen assembly and a second screen assembly with respect to a screen assembly holding apparatus of a vibratory separator or shale shaker into or onto which the screen assemblies are mountable, the method including: positioning at least a portion of a first screen assembly with respect to the screen assembly holding apparatus; connecting a second screen assembly to the first screen assembly with releasably cooperating material on each screen assembly; and moving the first screen assembly and the second screen assembly together with respect to the screen assembly holding apparatus, the screen assemblies held together while moving by engagement of the releasably cooperating material on one screen assembly with the releasably cooperating material on the other screen assembly. Moving of the screen assemblies may include moving the first screen assembly to insert the first screen assembly and the second screen assembly into the screen assembly holding apparatus or moving the first screen assembly to remove both the first screen assembly and the second screen assembly from the screen assembly holding apparatus.

In certain aspects, the present invention discloses a method for manipulating a first screen assembly and a second screen assembly with respect to a screen assembly holding apparatus of a vibratory separator or shale shaker into or onto which the screen assemblies are mountable, the method including: positioning at least a portion of a first screen assembly with respect to the screen assembly holding apparatus, the first screen assembly having a first recess and the second screen assembly having a second recess; connecting a second screen assembly to the first screen assembly with a connector, the connector having a first portion in the first recess and a second portion in the second recess; and moving the first screen assembly and the second screen assembly together with respect to the screen assembly holding apparatus. In certain aspect, at least a part of the connector is held loosely in one or both of the first recess and the second recess permitting freedom of movement of the first screen assembly with respect to the second screen assembly.

In certain aspects, the present invention discloses a pair of connected screen assemblies for use with a vibratory separator, the pair including a first screen assembly, a second screen assembly, the first screen assembly having a first amount of releasably cooperating material secured thereon, the second screen assembly having a second amount of releasably cooperating material secured thereon, and the first amount of releasably cooperating material sufficiently engaging the second amount of releasably cooperating material so that pulling on one of the first or second screen assemblies correspondingly moves the other screen assembly.

In certain aspects, the present invention discloses a pair of connected screen assemblies for use with a vibratory separator, the pair including a first screen assembly, a second screen assembly, the first screen assembly having a first recess, the second screen assembly having a second recess, a connector with a first portion in the first recess and a second portion in the second recess, and the connector releasably connecting the two screen assemblies so that pulling on one of the first or second screen assemblies correspondingly moves the other screen assembly.

In certain aspects, the present invention discloses a screen assembly with releasably cooperating material thereon for engaging releasably cooperating material on an adjacent screen assembly so two screen assemblies are movable together.

The present invention discloses a screen assembly with a recess therein for receiving and holding part of a connector usable in releasably connecting the screen assembly to an adjacent screen assembly.

The present invention discloses a screen assembly with one, two, three or more projections formed integrally thereof or permanently secured thereto with a part for installation in an adjacent screen assembly to releasably connect the two screen assemblies together.

The present invention, in certain aspects, methods for manipulating and/or moving a first screen assembly and a second screen assembly with respect to a screen assembly holding apparatus of a vibratory separator or shale shaker into or onto which the screen assemblies are mountable, the method including: positioning at least a portion of a first screen assembly with respect to a screen assembly holding apparatus; connecting a second screen assembly to the first screen assembly with releasable apparatus and/or material; and moving the first screen assembly and the second screen assembly together with respect to the screen assembly holding apparatus.

The present invention, in certain embodiments, discloses systems and methods for positioning screen assemblies on or within screen mounting structures on separators or shakers and for facilitating the removal of the screen assemblies. In certain aspects, systems according to the present invention include screen assemblies with complimentary mating structure and/or apparatus that interconnects adjacent screen assemblies on mounting structure to facilitate their removal from the mounting structure. In certain particular aspects, the mounting structure is a channel structure, including but not limited to, “C” or “U” channel mounts. In other aspects, screens are positioned on a support deck and appropriate connector(s), holding, or wedging structure or devices are use to releasably hold screen assemblies together.

In certain embodiments adjacent screen assemblies are provided with releasable meshing, interconnecting, or interlocking parts so that removal of one of the screen assemblies results in the removal of one or more other interconnected screen assemblies from the mounting structure. In one particular aspect a first screen assembly has one or more spaced-apart lips and an adjacent screen assembly has one or more corresponding lips which are movable to interlock with the lip(s) of the first screen. In other aspects a first screen assembly has one or more recesses sized and configured for releasably holding corresponding projection(s) of a second adjacent screen assembly to releasably connect the two screen assemblies; or both of two adjacent screen assemblies have adjacent recesses, holes, and/or indentations into which is put a connector to releasably hold the two screen assemblies together.

It is within the scope of the present invention to use releasably cooperating material, e.g. hook-and-loop material e.g. VELCRO (Trademark) material, or releasable fastener material, e.g. 3M DUAL LOCK (Trademark) material with or instead of any interconnecting or interlocking structure according to the present invention. In other embodiments a plug or pin extends into holes in two adjacent screens to releasably hold the screens together; or a plug or pin end which is an integral part of one screen assembly projects into a corresponding hole in an adjacent screen assembly to releasably secure the two screen assemblies together. In one particular aspect one or more movable pieces of releasably cooperating material straps or pieces on one screen are releasably attached to one or more corresponding pieces of such material on an adjacent screen to releasably hold the two screens together. “RCM material” includes, but is not limited to, known hook-and-loop cooperating material and includes, but is not limited to, snap-together stemmed reclosable fastener material, e.g., but not limited to 3M DUAL LOCK (Trademark) Reclosable Fasteners and fasteners and fastener material disclosed in U.S. Pat. No. 5,077,870 and in the references cited therein and in U.S. application Ser. No. 09/758,764 filed Jan. 11, 2001; Ser. No. 10/321,996 filed Dec. 17, 2002; Ser. No. 10/053,928 filed Jan. 24, 2002; Ser. No. 10/745,002 filed Dec. 23, 2003; Ser. No. 10/689,111 filed Oct. 20, 2003; and Ser. No. 09/908,092 filed Jul. 18, 2001—all of said patent and said applications incorporated herein fully for all purposes.

The present invention, in certain aspects, discloses a screen assembly for use in a vibratory separator or shale shaker, the screen assembly having a body, the body having a first end and a second end, the second end spaced-apart from the first end; a seal; a seal holder on the first end of the body releasably holding the seal; the seal having a recess and the seal holder having a projection for projecting into the recess of the seal. The present invention, in at least certain aspects, provides a vibratory separator with a screen assembly mounting structure, support or basket which has side walls adjacent one or more screen assemblies mounted therein or thereon. At least one end or side of a screen assembly abuts an interior surface of a side wall or of an end of the basket etc. Seal holding structure removably holds seal member apparatus. An access opening is provided in the wall or end of the basket etc. A movable (e.g. bolted, hinged, removable or openable) door (or cover) selectively closes off the access opening. By opening the door, removing the door, or moving the door access is provided to the seal and to the seal holding structure permitting the seal to be removed and inspected and, if needed, replaced.

It is, therefore, an object of at least certain preferred embodiments of the present invention to provide:

New, useful, unique, efficient, non-obvious systems and methods for releasably mounting screen assemblies in vibratory separators;

Such systems and methods which include releasable interconnection of adjacent screen assemblies to enhance their stability on or within mounting structure and/or to facilitate their easy removal from such structure;

Such systems and methods that include releasable interlocking structure or apparatus for releasably holding adjacent screen assemblies together in a vibratory separator or shale shaker;

Such systems and methods that provide an enhanced sealing effect between adjacent screen assemblies; and

Such systems and methods which provide correct foolproof positioning of screen assemblies in vibratory separators or shale shakers with no undesirable space between screen assemblies.

New, useful, unique, efficient, non-obvious vibratory separators, shale shakers, screen assemblies, screen assembly seals, holders for them, and methods for accessing seals;

Such separators and shakers with seal access systems which permit the efficient inspection of seals and, if needed, replacement;

Such separators and shakers in which screen assemblies need not be removed and then reinstalled to inspect and/or replace such seals; and

New, useful, unique, efficient, non-obvious seals for sealing a screen/mounting structure interface.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a perspective view of a screen assembly according to the present invention.

FIG. 2A shows a step in the interconnection of two screen assemblies as in FIG. 1.

FIG. 2B shows the two screen assemblies of FIG. 2A connected.

FIG. 3A is a perspective view of a screen assembly according to the present invention.

FIG. 3B is a perspective view of a screen assembly according to the present invention.

FIG. 4A shows connection structures according to the present invention for screen assemblies according to the present invention.

FIG. 4B shows connection structures according to the present invention for screen assemblies according to the present invention.

FIG. 4C shows connection structures according to the present invention for screen assemblies according to the present invention.

FIG. 4D shows connection structures according to the present invention for screen assemblies according to the present invention.

FIG. 5A is a perspective view of a screen assembly according to the present invention.

FIG. 5B is an enlargement of parts of the screen assemblies of FIG. 5A.

FIG. 6 is a top view of screen assemblies according to the present invention.

FIG. 7 is a perspective view of parts of screen assemblies according to the present invention.

FIG. 8A is an exploded view of a screen assembly according to the present invention.

FIG. 8B is a cross-section view of part of two screen assemblies as in FIG. 8A.

FIG. 8C is a cross-section view of part of two screen assemblies as in FIG. 8A.

FIG. 8D is a partial cross-section view of a screen assembly according to the present invention.

FIG. 9A is a perspective view of two screen assemblies according to the present invention.

FIG. 9B is a bottom view of one of the screen assemblies of FIG. 9A.

FIG. 9C is a top view of one of the screen assemblies of FIG. 9A.

FIG. 10A is a perspective view of two screen assemblies according to the present invention.

FIG. 10B is a side cross-section view of the screen assemblies of FIG. 10A.

FIG. 11 is a perspective view of screen assemblies according to the present invention.

FIG. 12 is a top view of connection pins for connecting screen assemblies according to the present invention.

FIG. 13 is a perspective view of a screen assembly according to the present invention.

FIG. 14 is a perspective view of screen assemblies according to the present invention.

FIG. 15 is a bottom view of a prior art support for screening material for a screen assembly.

FIG. 16 is a side cross-section view showing connecting according to the present invention of two screen assemblies as in FIG. 15.

FIG. 17 is a side view of a basket for a vibratory separator or shale shaker according to the present invention.

FIG. 18 is an enlargement of seal holding structure of the separator or shaker of FIG. 1.

FIG. 19 is a top view of a screen assembly in the separator or shaker of FIG. 1.

FIG. 20A is a perspective view of a seal according to the present invention which is shown in cross-section in FIG. 18.

FIG. 20B is an end view (of both ends) of the seal of FIG. 20A.

FIG. 20C is a top view of the seal of FIG. 20A.

FIG. 20D is a bottom view of the seal of FIG. 20A.

FIG. 20E is a front view of the seal of FIG. 20A.

FIG. 20F is a rear view of the seal of FIG. 20A.

FIG. 20G is a side cross-section view of a seal according to the present invention in seal holders according to the present invention.

FIG. 20H is a side cross-section view of a seal according to the present invention in seal holders according to the present invention.

FIG. 20I is a bottom view of a seal according to the present invention.

FIG. 21 is a side cross-section view of a seal structure according to the present invention.

FIG. 22 is a side cross-section view of a seal structure according to the present invention.

FIG. 23 is a side cross-section view of a seal structure according to the present invention.

FIG. 24 is a side cross-section view of a seal structure according to the present invention.

FIG. 25 is a perspective view of a shale shaker according to the present invention.

FIG. 26A is a top view of a screen assembly according to the present invention.

FIG. 26B is a front view of the screen assembly of FIG. 26A.

FIG. 26C is a rear view of the screen assembly of FIG. 26A.

FIG. 26D is a side cross-section view of two screen assemblies as in FIG. 26A in a shale shaker.

FIG. 26E is a cross-section of a seal and seal holder of the screen assembly of FIG. 26A.

FIG. 27A is a side view in cross-section of screen assemblies according to the present invention.

FIG. 27B is a side cross-section view of the screen assemblies of FIG. 27A.

FIG. 28A is a top view of interconnectible screen assemblies according to the present invention.

FIG. 28B is a side view of the screen assemblies of FIG. 28A

FIG. 28C is a side view that shows the screen assemblies of FIG. 28A connected together.

FIG. 28D is a cross-section view showing a screen assembly as in FIG. 28A abutting a separator or shaker.

FIG. 28E is a top view of interconnectible screen assemblies according to the present invention.

FIG. 28F is a side view of the screen assemblies of FIG. 28B.

FIG. 29A is a side view of interconnectible screen assemblies according to the present invention.

FIG. 29B is a side view that shows the screen assemblies of FIG. 29A connected together.

FIG. 29C is a cross-section view showing a screen assembly as in FIG. 29A abutting a separator or shaker.

FIG. 30A is a top view of interconnected screen assemblies according to the present invention.

FIG. 30B is a cross-section view along line 30B-30B of FIG. 30A.

FIG. 30C is a cross-section view showing a screen assembly as in FIG. 30A abutting a separator or shaker.

FIG. 31A is a side cross-section view of a screen assembly according to the present invention abutting a separator shaker.

FIG. 31B is a side view of the screen assembly and shaker of FIG. 31A with the seal not yet compressed.

FIG. 32A is a side view of interconnected screen assemblies according to the present invention.

FIG. 32B is a cross-section view showing a screen assembly as in FIG. 32A abutting a separator or shaker.

FIG. 32C is a side view that shows the screen assembly of FIG. 32B with its seal not compressed.

FIG. 33A is a side view in cross-section of interconnected screen assemblies according to the present invention.

FIG. 33B is a side view in cross-section of a seal as in the screen assembly of FIG. 33A showing the seal not compressed.

FIG. 33C is a cross-section view showing a screen assembly as in FIG. 33A abutting a separator or shaker.

FIG. 34 is a top view of interconnectible screen assemblies according to the present invention.

FIG. 35A is a top view of interconnected screen assemblies (shown partially) according to the present invention.

FIG. 35B is a top view that shows the screen assemblies of FIG. 35A separated.

FIG. 35C is a cross-section view along line 35C-35C of FIG. 35A.

FIG. 35D is a top view of a screen assembly (shown partially) according to the present invention.

FIG. 36A is a top view of interconnected screen assemblies (shown partially) according to the present invention.

FIG. 36B is an end view of one of the screen assemblies (shown partially) of FIG. 36A.

FIG. 36C is a top view of a screen assembly (shown partially) according to the present invention.

FIG. 36D is a top view of the connectors shown FIG. 36A.

FIG. 37A is an end view of a screen assembly (shown partially) according to the present invention.

FIG. 37B is a top view of a screen assembly (shown partially) according to the present invention.

FIG. 37C is a top view of a connector for connecting two screen assemblies according to the present invention as in FIG. 37A.

FIG. 38A is a top view of interconnected screen assemblies (shown partially) according to the present invention.

FIG. 38B is an end view of one of the screen assemblies of FIG. 38A.

FIG. 38C is a cross-section view along line 38C-38C of FIG. 38A.

FIG. 38D is a top view of a connector connecting the two screen assemblies of FIG. 38A.

FIG. 38E is a top view of a connector connecting the two screen assemblies of FIG. 38A.

FIG. 38F is a top view of interconnected screen assemblies (shown partially) according to the present invention.

### DETAILED DESCRIPTION OF THE INVENTION

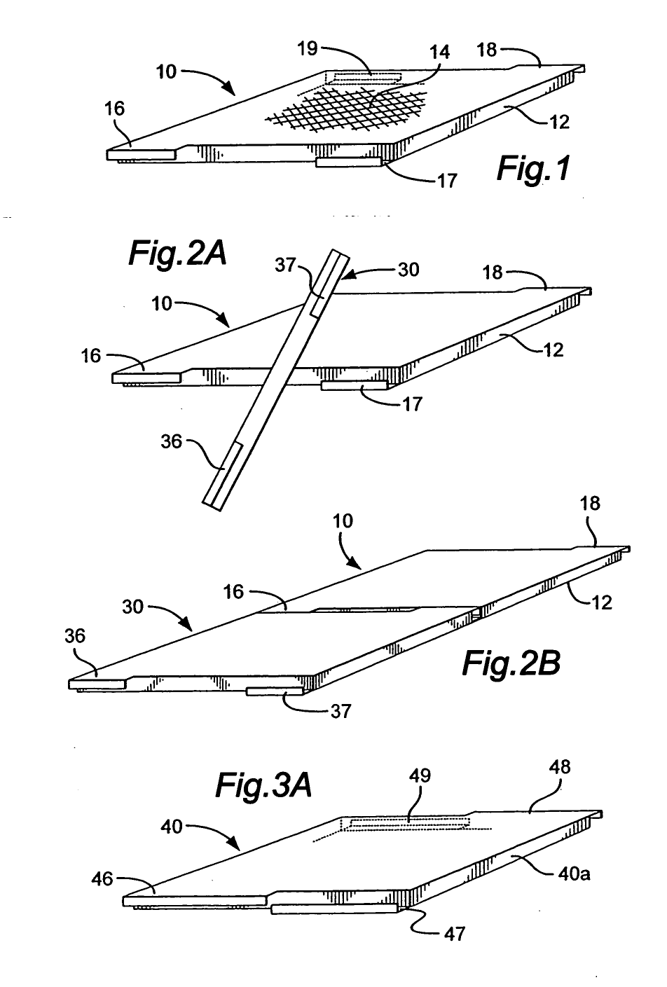

FIG. 1 shows schematically a screen assembly 10 according to the present invention for a vibratory separator or shale shaker which has a support or frame 12 with screening material 14. It is to be understood that it is within the scope of the present invention for side and/or cross members of the support or frame 12 to be like any such known support or frame members, including but not limited to, those of supports and frames in U.S. Pat. Nos. 5,417,793; 5,417,859; 5,417,858; 6,443,310; 6,439,392 and in the prior art cited therein. According to the present invention end members 16, 17, 18 and 19 of the frame 12 have lips and projecting therefrom. Each lip has a vertical portion connected to a horizontal portion . Such portions can be added to, secured to or formed integrally of any suitable known support or frame member to effect a frame or support according to the present invention. Alternatively, the lips may be generally curved with no portion at an abrupt angle to the other.

It is to be understood that the screening material 14 may be any known screening material of single or multiple layers of any known material [e.g. metal, metal alloy (e.g., brass, bronze) plastic, fiberglass, PTFE, composite) and may extend over an entire upper surface of the support or frame 12, with multiple layers fused, sewed, bonded, adhered, sintered, welded, and/or glued together at discrete points, along lines, and/or across substantially the entire surface area of the screening material.

As shown in FIGS. 2A and 2B the screen assembly 10 can be interconnected with a similar screen assembly 30 by juxtaposing the screen assemblies as shown in FIG. 2A and then moving them into position with respect to each other as shown in FIG. 2B with lips 16 and a corresponding lip of the screen assembly 30 (not shown) interengaging each other and lips 17 and a corresponding lip of the screen assembly 30 (not shown) interengaging each other. The screen assembly 30 has lips 36 and 37 (like the lips 16, 36 of the screen assembly 10) which are visible in the views of FIGS. 2A and 2B and lips not shown like the lips 18, 19.

With corresponding lips engaged as in FIG. 2B, moving the screen assembly 30 results in moving of the screen assembly 10 so that, when the screen assemblies are positioned on a support deck or in a mounting structure of a separator or shaker, pulling on the screen assembly closest to an end of the shaker or separator or closest to an entry insertion end of mounting structure results in pulling the screen assembly that is connected to the screen assembly being pulled. Prior to emplacement of or insertion of a second screen assembly according to the present invention (like the screen assembly 30), when a first screen assembly according to the present invention is either wholly or partially emplaced on or inserted into mounting structure, the second screen assembly is connected to the first screen assembly and pushing on the second screen assembly pushes the first screen assembly further onto a deck or into mounting structure while the first screen assembly remains connected to the second screen assembly. The second screen assembly is then moved to its desired position on the deck or within the mounting structure.

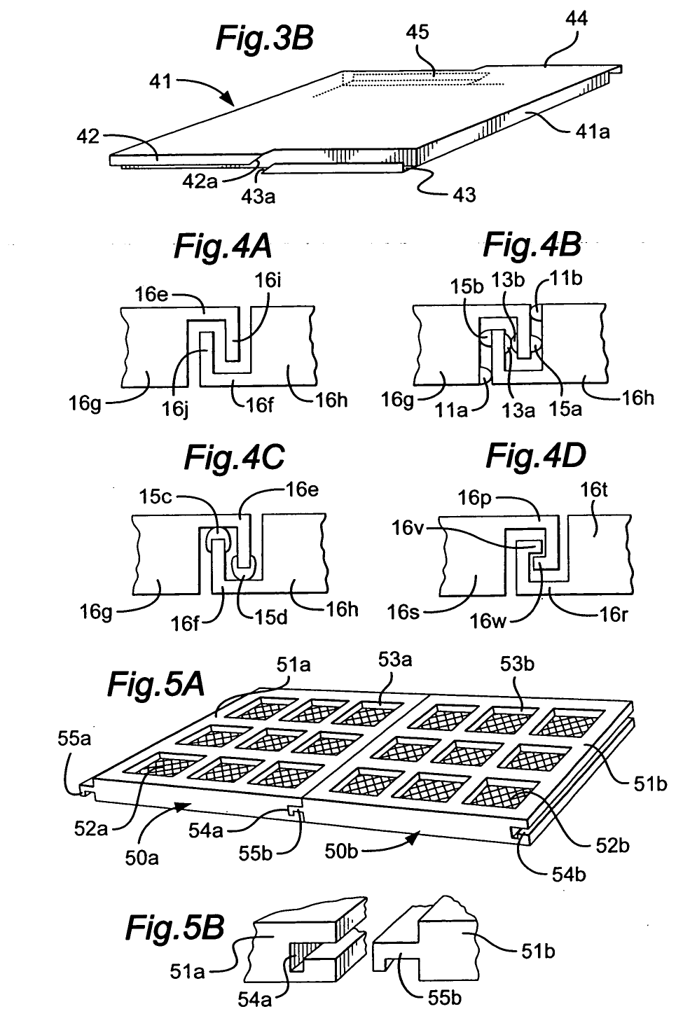

FIGS. 3A and 3B show screen assemblies according to the present invention with different engaging lip configurations. A screen assembly 40 with a frame 40a shown in FIG. 3A has engaging lips 46, 47, 48 and 49 (like the lips 16-19, FIG. 1) but which have a greater linear extent so that, when two similar screen assemblies are connected (as are the two screen assemblies in FIG. 2B) there is little or no gap between a portion of the lip 46 and an adjacent portion of an adjacent lip that is engaging the lip 47. Two screen assemblies like the screen assembly 40 may be connected by aligning lips of the two screen assemblies and sliding them together so that corresponding lips engage each other; or, if the lips are made of sufficiently flexible material, the lips can be flexed and moved together to effect desired interengagement.

FIG. 3B shows a screen assembly 41 with lips 42, 43, 44 and 45 (like lips of the screen assemblies of FIGS. 1 and 3A) but which has an inclined edge, e.g. 42a, 43a, on each lip with sufficient space therebetween so that two screens with such lips can be connected either by aligning lips and sliding screens together or by manipulating two such screens as shown in FIG. 2A. Frames 40a and 41a, respectively, may be like any of the supports or frames 12, FIG. 1; and any screening material, like any of the screening material 14, FIG. 1, may be used on the screening assemblies 40 and 41.

FIG. 4A shows the interengagement of two lips 16e, 16f (like the lips 16 and 17, respectively, FIG. 1) of screen assemblies 16g, 16h, respectively (shown partially). In use, the lip 16e may be moved to abut the screen assembly 16h and/or the lip 16f may abut the screen assembly 16g. To remove such screen assemblies from a screen assembly mounting structure or deck, pulling on the screen assembly 16g brings a vertical portion 16i of the lip 16e into contact with a vertical portion 16j of the lip 16f so that pulling the screen assembly 16g results in pulling of the screen assembly 16h.

FIG. 4B illustrates optional seal members 11a, 11b, 13a, 13b, 15a, and 15b which may be used on the lips and screen assemblies of FIG. 4A (and which may, according to the present invention, be used on any lip or lip portion or screen assembly part of a screen assembly according to the present invention). Any known seal or gasket material may be used for any of these seals including, but not limited to, metal, plastic, rubber, fiberglass, PTFE, and composite materials. The seals may be positioned so that a seal is connected to part of a lip or screen assembly and touches an opposing part of a lip or screen assembly (e.g. seals 11a, 15b, 15a, 11b) or seals can be positioned so that one seal contacts another seal (e.g. seals 13a, 13b). Seals may be discrete seal portions and parts and there may be, in certain aspects according to the present invention, a plurality of adjacent and/or spaced-apart seals; or a seal may extend along and completely cover or encompass an entire edge of a lip or an entire gap or interface area between parts. FIG. 4C shows seals 15c, 15d on end edges of lips 16e, 16f.

FIG. 4D shows alternative embodiments 16p, 16r, for screen assemblies 16s, 16t which are like lips 16e, 16f (FIG. 4A), but which have horizontal portions 16v, 16w (horizontal as viewed in FIG. 4D) which provide additional interengaging portions for the lips. Any lip of any screen assembly according to the present invention may have portions like the portions 16v, 16w.

FIGS. 5A and 5B show screen assemblies 50a and 50b according to the present invention, each of which has a frame 51a, 51b, respectively, with screening material 52a, 52b, respectively secured thereto and exposed within a plurality of frame openings 53a, 53b, respectively. Each frame 51a, 51b has a recess 54a, 54b, respectively, for receiving and holding a corresponding connection member 55a, 55b, respectively. The two screen assemblies 50a and 50b are connected together by sliding the connection member 55b into the recess 54a. The screen assemblies 50a, 50b and their parts (as with any screen assemblies according to the present invention) may be made of any materials mentioned above for the items of FIGS. 1-4D.

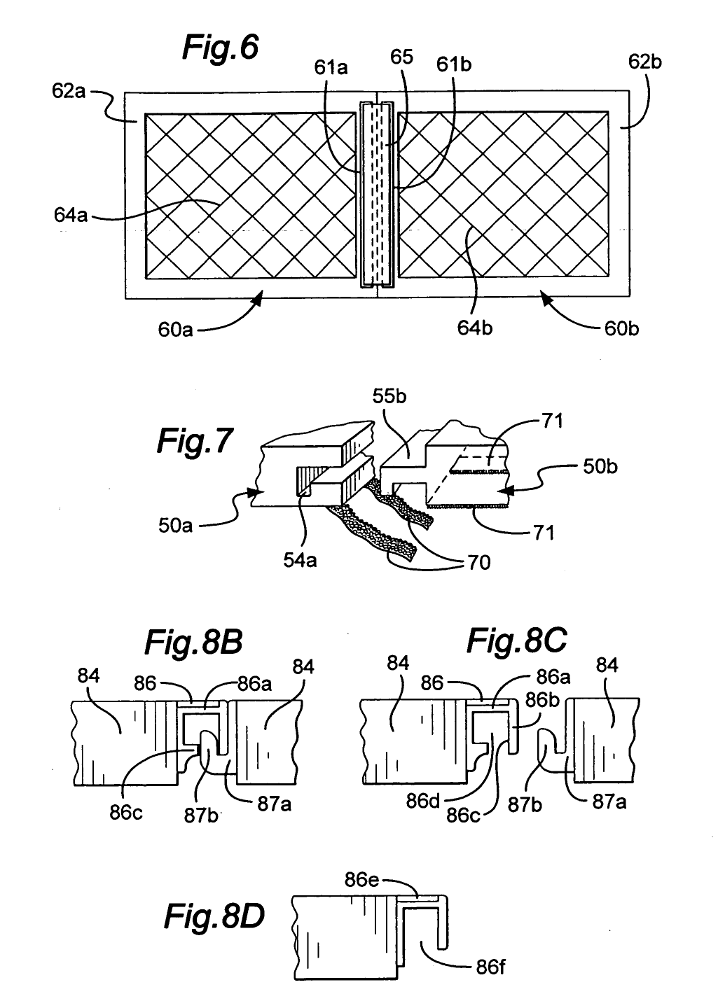

FIG. 6 shows screen assemblies 60a, 60b according to the present invention each of which has a frame 62a, 62b (which may be like any support or frame of the screen assemblies of FIGS. 1-5A) with screening material 64a, 64b, respectively, which may be like any screening material described herein for any screen assembly according to the present invention. Each screen assembly 60a, 60b, has a portion of releasably cooperating hook-and-loop fastener material 61a, 61b, respectively, [e.g. VELCRO (trademark) material] to which is releasably attachable a piece of corresponding releasably cooperating fastener material 65 to releasably connect the two screen assemblies 60a, 60b together. Each of the screen assemblies 60a, 60b may also have any screen assembly interconnection apparatus and/or structure disclosed herein. The material 65 is shown as extending over almost all of an interface between the two screen assemblies 60a, 60b; but it is within the scope of this invention to use a similar piece of such material, multiple spaced-apart pieces, or one or more pieces to completely cover the interface and such material may also serve to close off the interface so nothing can flow between the screen assemblies (and such material may be used with any screen assemblies according to the present invention). The material shown in FIG. 6 may be used on the top and/or on the bottom of adjacent screen assemblies.

FIG. 7 shows the screen assemblies 50a, 50b of FIG. 5A with movable straps 70 of releasably cooperating fastener material on the screen assembly 50a which are movable to contact and cooperate with amounts 71 of such material in corresponding positions on the screen assembly 50b to releasably connect the two screen assemblies together. One, two, three, four or more of these straps may be used on any screen assembly according to the present invention.

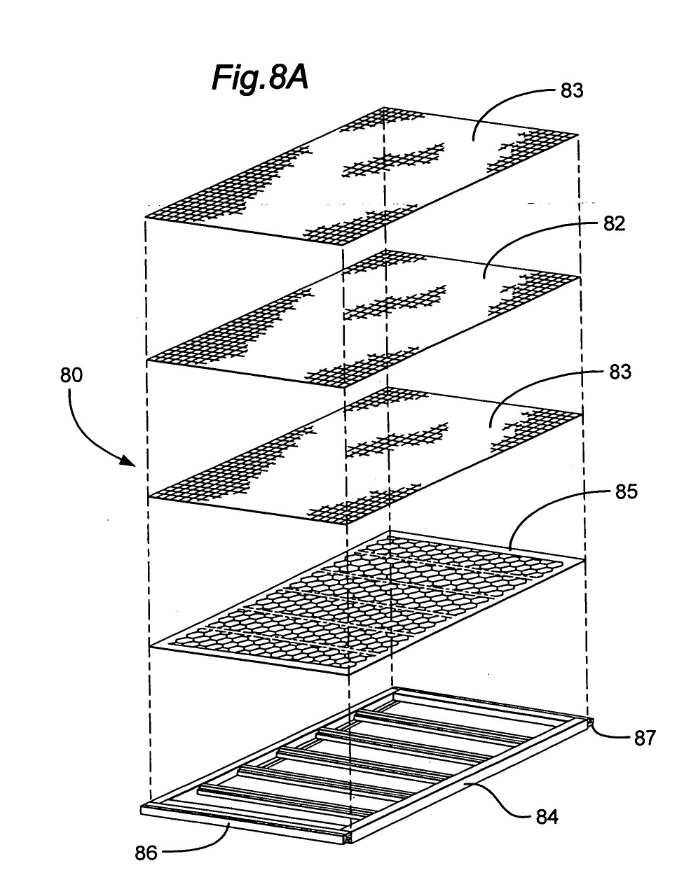

FIGS. 8A-8C show a screen assembly 80 which is similar to those disclosed in U.S. Pat. No. 6,439,392 issued Aug. 27, 2002 (incorporated fully herein for all purposes); but which has screen interconnection structures at both ends of the screen assembly so that two adjacent screen assemblies 80 may be interconnected for movement (pushing, pulling) with respect to screen mounting structure of a separator or shaker. The screen assembly 80 has a frame 84 on which are mounted and secured, optionally, a perforated plate 85, and one, two, three, or more layers 81, 82, 83 of screening material (which may be any screening material disclosed herein, including, but not limited to the screening material 14, FIG. 1, and its various aspects and embodiments). Any frame or support members disclosed or described herein may be used for the members of the frame 84 and any support or plate may be used for the optional perforated plate 85. The frame 84 has a connector 86 at one end and corresponding connection structure 87 at the other end. The connector 86 has a body 86a with a lip 86b, an opening 86c, and an inner space 86d. The connector structure 87 has a body 87a with a lip 87b that is sized and configured for insertion into and through an opening 86c. As with any connection structure disclosed herein, the connector 86 and the connection structure 87 may be made of the same material as the frame 84 or of different material and be connected to or formed integrally of the frame 84.

FIG. 8B shows the lip 87b engaged with the connector 86 and projecting into the space 86d. FIG. 8D shows an alternative embodiment 86e for the connector 86 in which an opening 86f is larger than the opening 86c to facilitate insertion of a lip 87b.

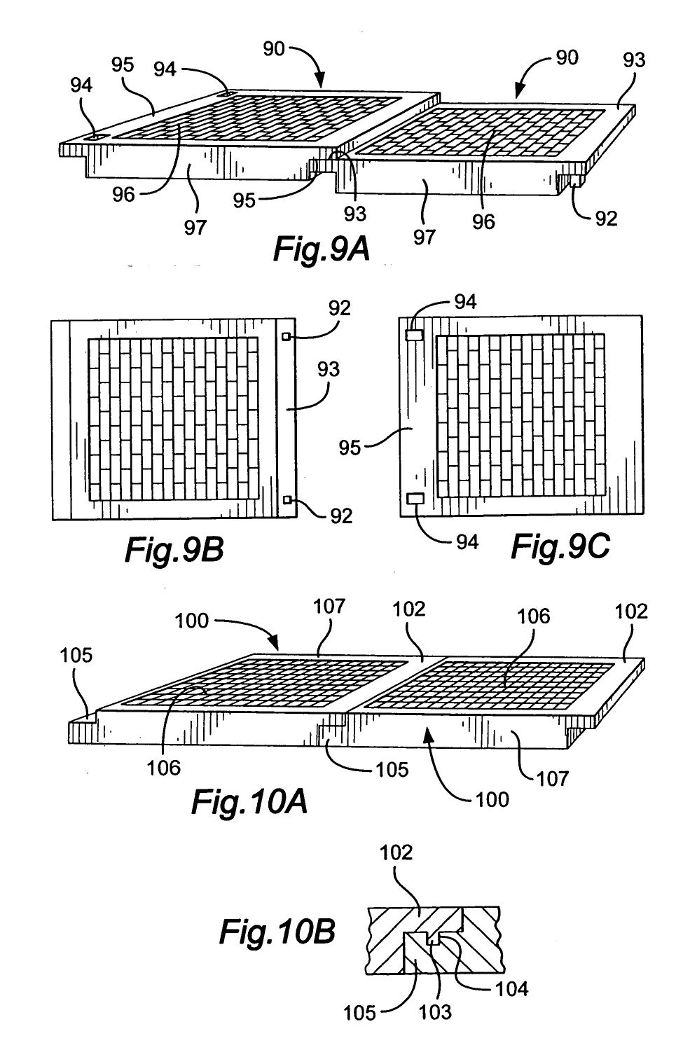

FIGS. 9A-9C show screen assemblies 90 according to the present invention which are like screen assemblies disclosed in U.S. Pat. No. 6,443,310 issued Sep. 3, 2002 (and incorporated fully herein for all purposes); but which have downwardly projecting pins 92 projecting down from a bottom of a screen side 93 which are sized and configured for releasable receipt within corresponding recesses 94 in a top of a screen side 95. One, two, three, four or more pins 92 with corresponding recesses 94 may be used (and may be used on any screen assembly disclosed herein according to the present invention) to provide for interconnection of two screen assemblies. Screening material 96 on frames 97 is like the screening material 14, FIG. 1.

FIGS. 10A and 10B show screen assemblies 100 according to the present invention each of which has a side 102 with one, two, three (or more) downwardly projecting pins 103 which are received and releasably held in corresponding interior recesses 104 in a side 105. Screening material 106 on frames 107 is like the screening material 14, FIG. 1.

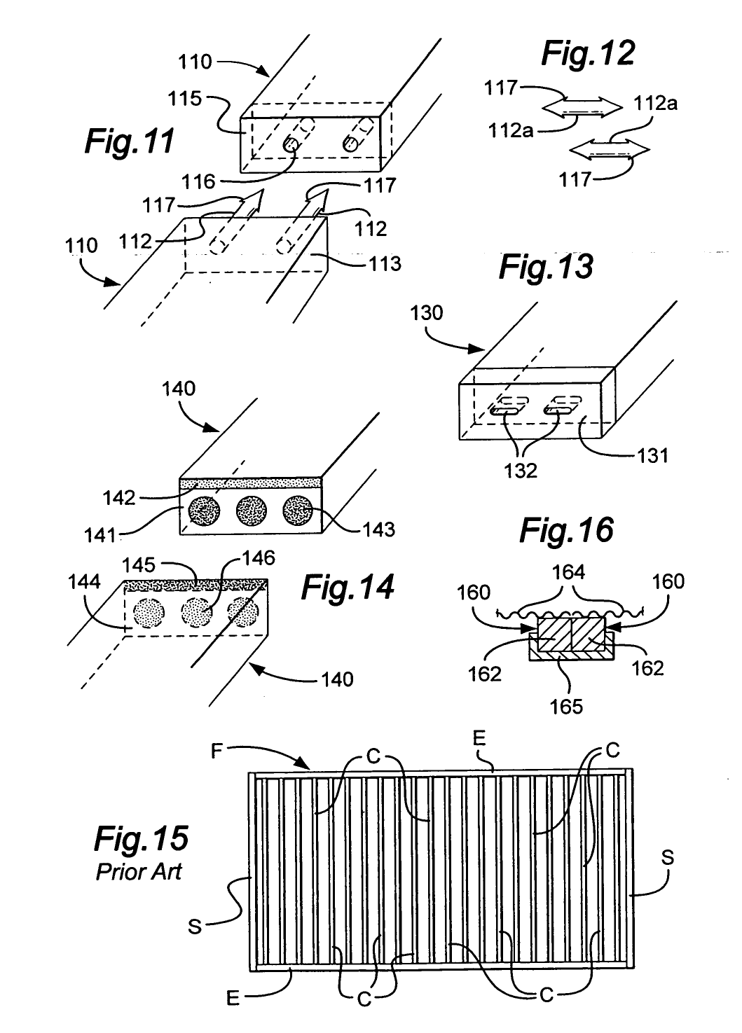

FIG. 11 shows schematically screen assemblies 110 (each shown partially) with end members having one, two, three or more projecting pins 112 on one end 113 thereof and an opposing end 115 thereof having corresponding holes 116 for releasably receiving the pins 112. The pins 112 may have laterally projecting or “barbed” portions 117 to facilitate holding of the pins 112 within the holes 116. The pins 112 may be connected to or formed integrally of the screen assemblies 110; or, as illustrated in FIG. 12, separate separable pins 112a may be used with screen assemblies both ends of which have holes like the holes 116, according to the present invention. Barbed portions 117 may be deleted and the pins held in place with a friction fit and/or adhesive or glue. Instead of pins like the pins 112 or 112a, bolts, screws, or nut/bolt combinations may be used to connect screens together.

It is within the scope of this invention to provide a screen assembly (like any disclosed or referred to herein) with one or more pins like the pins 92 or the pins 103 which are positioned so that the pin(s) are received within a corresponding hole or recess in a basket, support deck, or screen assembly mounting structure to provide for correct positioning of a screen assembly and/or to stabilize a screen assembly during positioning and during separator or shaker operation. The pin(s) may have a uniform diameter or they may be tapered and correspondingly tapered holes or recesses may be used.

FIG. 13 shows an end 131 of a screen assembly 130 according to the present invention which has two slots 132 therethrough for receiving a part of a tool insertable therein to facilitate movement of the screen assembly with respect to a support deck or mounting structure. Alternatively, pins may be used in the slots 132 (like the pins of FIG. 12).

FIG. 14 shows schematically and partially two screen assemblies 140 according to the present invention which have at a first end 141 amounts of releasably cooperating fastener material 142 and 143 and at another end 144 corresponding amounts of such material 145 and 146 to releasably connect the screen assemblies together. The amounts 142 and 145 of material may also serve to close off and/or seal the interface between two screen assemblies 140 placed end-to-end in or on separator or shaker mounting structure.

It is to be understood that it is within the scope of the present invention for any screen assembly according to the present invention disclosed herein to have the connection structure and/or material disclosed in FIGS. 11-14.

FIG. 15 shows a prior art tubular frame F for a screen assembly which has ends E, sides S, and crossmembers C. FIG. 16 shows partially adjacent screen assemblies 160 according to the present invention each with a frame 162 like the frame F with screening material 164 (like the screening material 14, FIG. 1) on the frame 162. A clip 165 engages portions of frame end members of each adjacent frame 162 and releasably holds together the two screen assemblies 160 so that movement (pulling, pushing) of one results in corresponding movement of the other, e.g., with respect to (and onto, into or out of) screen assembly mounting structure or support deck of a separator or shaker. The clips 165 may be made of any suitable material, including any of those mentioned herein for screen assemblies or parts thereof.

The present invention, therefore, in at least certain aspects or embodiments, provides a method for manipulating a first screen assembly and a second screen assembly with respect to a screen assembly holding apparatus of a vibratory separator (e.g., but not limited to a shale shaker) into or onto which the screen assemblies are mountable, the method including positioning at least a portion of a first screen assembly with respect to screen assembly holding apparatus of a vibratory separator, connecting a second screen assembly to the first screen assembly, and moving the first screen assembly and the second screen assembly together with respect to the screen assembly holding apparatus. Such a method may include one or some (in any possible combination) of the following: wherein first and second screen assemblies are insertable into the screen assembly holding apparatus and the method further includes moving the first screen assembly to insert the first screen assembly and the second screen assembly (or parts thereof) into the screen assembly holding apparatus; moving the first screen assembly to remove both the first screen assembly and the second screen assembly (or part thereof) from the screen assembly holding apparatus; wherein the screen assembly holding apparatus includes a support deck and the first and second screen assemblies are emplaceable on the support deck, the method further includes moving the first screen assembly to move together the first screen assembly and the second screen assembly on or onto the support deck; moving the first screen assembly to remove the first screen assembly from the support deck and to move all or at least a portion of the second screen assembly to facilitate removal of the second screen assembly from the support deck; removing the first screen assembly from the screen assembly holding apparatus and thereby pulling the second screen assembly with respect to the screen assembly holding apparatus with the first screen assembly to facilitate removal of the second screen assembly from screen assembly holding apparatus; wherein the vibratory separator is a shale shaker for processing drilling fluid with solids entrained therein; wherein the first screen assembly and the second screen assembly each have interconnection apparatus thereon for releasably interconnecting the first screen assembly with the second screen assembly; wherein the interconnection apparatus includes at least one lip on each screen assembly, the at least one lip configured and positioned for engagement by a corresponding adjacent lip to releasably interconnect the screen assemblies, the method further includes engaging the at least one lip on the first screen assembly with the at least one lip on the second screen assembly to releasably connect the screen assemblies together; wherein each lip has at least one seal apparatus thereon for sealing an interface between the at least one lip of the first screen assembly and the at least one lip of the second screen assembly, or for sealing a lip/screen assembly interface; wherein the at least one lip on the first screen assembly is two spaced-apart lips thereon and the at least one lip on the second screen assembly is two corresponding spaced-apart lips thereon; wherein each lip has a length, each lip is connected to a side of a screen assembly that has a length, the lengths of the sides of the screen assemblies being substantially equal, and a combined length of adjacent lips upon interconnection of the two screen assemblies is substantially equal to the length of one of said sides of the screen assemblies; wherein the lips of the screen assemblies are sized so that upon interengagement of the lips of the two screen assemblies there is a gap between the lips; wherein the lips of the screen assemblies are sized so that upon interengagement of the lips of the two screen assemblies there is a no gap or almost no gap between the lips; wherein the interconnection apparatus includes at least one piece of releasably cooperating fastener material on each screen assembly, the at least one piece of releasably cooperating fastener material configured and positioned to releasably interconnect the screen assemblies, the method further includes connecting the first screen assembly to the second screen assembly by bringing into connecting contact the at least one piece of releasably cooperating fastener material on the first screen assembly with the at least one piece of releasably cooperating fastener material on the second screen assembly; wherein the screen assembly holding apparatus includes opposed channel members, each channel member having an opening defined by parts of the channel member, the screen assemblies insertable into the openings; wherein the screen assembly holding apparatus includes a support deck on which the screen assemblies are emplaceable and securement apparatus for securing the screen assemblies in place on the support deck, the method further includes emplacing the screen assemblies on the support deck, and securing the screen assemblies in place with the securement apparatus; wherein the first screen assembly and the second screen assembly each have interconnection apparatus thereon for interconnecting the first screen assembly with the second screen assembly, the interconnection apparatus is at least one strap on the first screen assembly, the at least one strap including releasably cooperating fastener material, and at least one corresponding amount of releasably cooperating fastener material on the second screen assembly, the method further includes connecting the at least one strap to the at least one corresponding amount of releasably cooperating fastener material to releasably connect the two screen assemblies together; wherein the interconnection apparatus is at least one pin projecting from the first screen assembly and at least one corresponding recess on the second screen assembly for releasably holding the at least one pin, the method further includes inserting the at least one pin into the at least one corresponding recess to releasably connect the screen assemblies together; wherein the at least one pin is formed integrally of the first screen assembly; and/or wherein the interconnection apparatus is at least one clip, the at least one clip configured for emplacement around a portion of each screen assembly, the method further includes connecting the two screen assemblies together with the at least one clip.

The present invention also provides a method for manipulating a first screen assembly and a second screen assembly with respect to a screen assembly holding apparatus of a vibratory separator into or onto which the screen assemblies are mountable, the method includes positioning at least a portion of a first screen assembly with respect to screen assembly holding apparatus of a vibratory separator, connecting a second screen assembly to the first screen assembly, and moving the first screen assembly and the second screen assembly together with respect to the screen assembly holding apparatus, wherein the first screen assembly and the second screen assembly each have interconnection apparatus thereon for interconnecting the first screen assembly with the second screen assembly, wherein the interconnection apparatus includes at least one lip on each screen assembly, the at least one lip configured and positioned for engagement by a corresponding adjacent lip to releasably interconnect the screen assemblies, the method further includes engaging the at least one lip on the first screen assembly with the at least one lip on the second screen assembly to releasably connect the screen assemblies together, wherein the at least one lip on the first screen assembly is two spaced-apart lips thereon and the at least one lip on the second screen assembly is two corresponding spaced-apart lips thereon, wherein the screen assembly holding apparatus has opposed channel members, each channel member having an opening defined by parts of the channel member, the screen assemblies insertable into said openings.

The present invention provides, therefore in at least certain aspects or embodiments, a screen assembly for use in treating fluid in a vibratory separator, the screen assembly having screening material, a support supporting the screening material, interconnection apparatus on the support for releasably connecting the screen assembly to an adjacent screen assembly. Such a screen assembly may have one or some (in any possible combination) of the following: wherein the interconnection apparatus has at least one lip projecting out from the support; at least one seal member on the at least one lip; wherein the at least one lip is two spaced-apart lips; wherein the two spaced-apart lips are of sufficient length that a gap or no gap is present upon engagement of similar lips of a similar adjacent screen assembly; the interconnection apparatus has an amount of releasably cooperating fastener material; wherein the amount of releasably cooperating fastener material is sufficiently large to cover an interface between the screen assembly and an adjacent screen assembly; the interconnection apparatus is at least one pin projecting from the support for releasable receipt within a corresponding hole of an adjacent screen assembly.

The present invention provides, therefore in at least certain aspects or embodiments, a screen assembly with a screening material support with at least one opening in the support for releasably receiving part of a tool useful for moving the screen assembly.

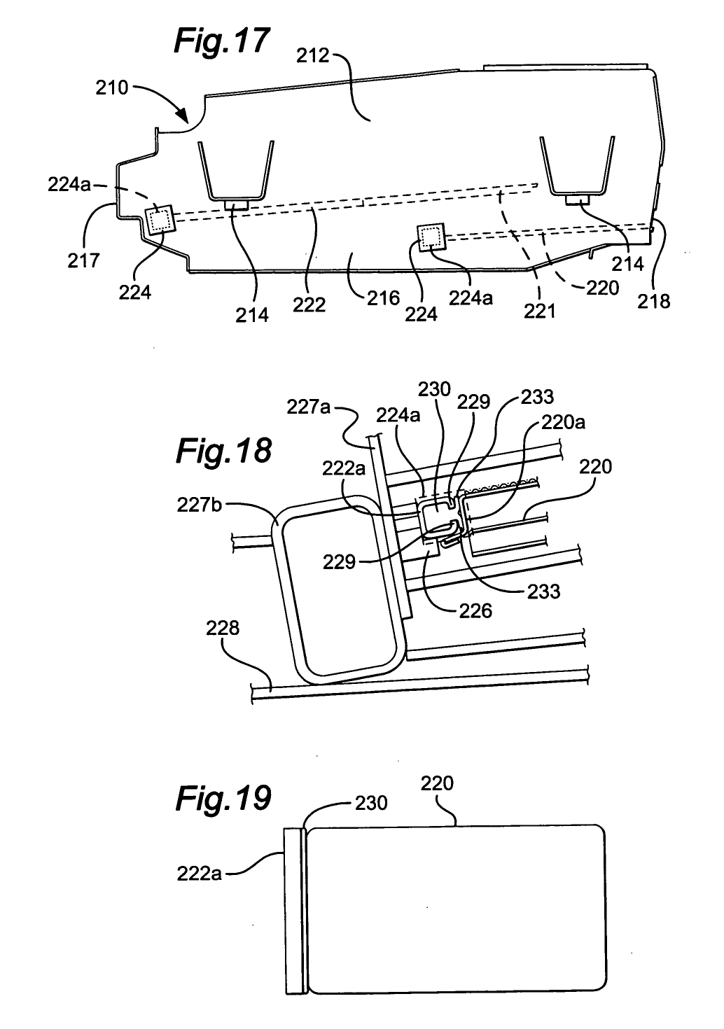

FIGS. 17-19 show a vibratory separator or shale shaker 210 (henceforth referred to as shaker 210) which has a basket 212 for holding a plurality of screen assemblies 220, 221, and 222. The basket 212 has spring mounts 214 and side walls 216 (one shown) with ends 217 and 218 interconnecting the two spaced-apart side walls. The screen assemblies 220 and 221 each have an ends 220a and 221a, respectively, which abuts a seal member mounted within the basket 212. As shown in detail in FIG. 18 the end 220a of the screen assembly 220 sealingly contacts a seal member 230 according to the present invention which is removably held within a seal holder 222a according to the present invention.

Adjacent each seal holder is a removable cover 224 which is secured (e.g. with bolts, not shown) over corresponding openings 224a through the side wall 216 of the basket 212. A dotted line 224b indicates the location of this opening in FIG. 18. Upon removal of the cover 224, the seal member 230 can be grasped and removed from the seal holder 222. If necessary, a new seal member can be installed in the seal holder 230 and the cover 224 replaced. It is within the scope of this invention to use doors hingedly connected over the openings. Seals or gasket may be used on the covers or doors to seal their interface with the basket wall. Alternatively the cover 224 is movably secured over the opening 224b (e.g. with a bolt or rod on which it can rotate) and is moved aside to access a seal member.

The seal holder 222 is secured to a support 226 which is connected to a structural member 227a within the shaker 210. The structural member 227a is itself connected to another structural member 227b which rests on a base 228 of the shaker 210.

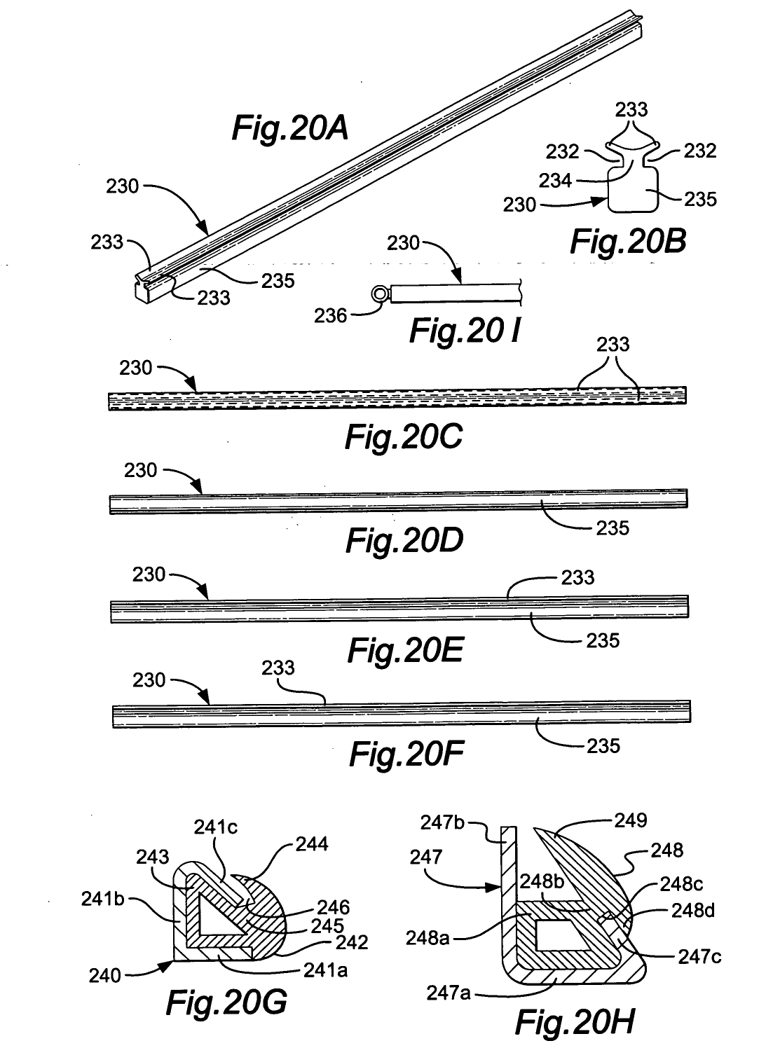

The seal member 230 as shown in FIGS. 20A-20F has at least one recess 232 (two shown in FIG. 20B) into which projects a projecting part 229 of the seal holder 222. The seal holder 222 has at least one (two shown in FIG. 18) projecting part 229. The seal member 230 has a body 235 from which projects a part 234. Two lips or arms 233 project from the part 234. Initially an obtuse angle is defined between the lips 233. The lips 233 are flexible so that upon contacting an end of a screen assembly they are movable resulting in an increased amount of the surface of the lips 233 contacting the end of the screen assembly, e.g. to move to a position as shown in FIG. 18. This flexibility enhances the sealing contact of the lips 233 against the end of the screen assembly. The seal member 230 (as is the case for any seal or seal member of FIGS. 20A, 20G-24 and any disclosed herein) may be made of any suitable known seal material, including, but not limited to neoprene, nitrile rubber, plastic, fiberglass, metal, wood, or composite material. In one particular aspect the seal member 230 is made of urethane, is about 1 inch in height, about ⅝ inches in width, about 29.5 inches long and has a hardness of 95 durometer. In certain aspects such a seal has a hardness of 70 durometer. Such a seal member is suitable for use in a shale shaker which is used to treat drilling fluid material from an earth wellbore. In one aspect, the lips 233 are deleted. As shown, the recesses 232 extend along the entire length of the seal member 230. This permits the seal member 230 to be installed from the side in a seal holder. In one aspect, the body 235 of the seal member 230 fills substantially all of he interior space of the seal holder 222 (as may be the case with any seal according to the present invention). As shown in FIG. 20I the seal member 230 may, optionally, (as may any seal or seal member according to the present invention) have a pulling apparatus 236 on one or both ends to facilitate removal from a seal holder. Although the pulling apparatus 236 is shown as a ring with an open center, the open center may be deleted or any suitable structure such as, but not limited to a tab or cylinder, may be used to facilitate movement of a seal or seal member.

FIG. 20G shows a seal holder 240 according to the present invention which has a lower part 241a, an upright part 241b, and a top part 241c projecting downwardly. A seal 242 has a body 243 releasably and removably disposed in an interior space of the seal holder 240. Optionally, the body 243 is hollow as shown (or it may be solid). A lip 244 is connected to or formed integrally of a projecting part 245. The projecting part 246 is connected to or formed integrally of the body 243. The seal holder 240 can be used in a vibratory separator or shale shaker as the seal holder 222, FIG. 18, is used. Preferably the shape of the interior space of the seal holder 240 and of the body 243 of the seal 242 are substantially the same. The lip 244 is optional. Preferably the seal 242 is flexible to enhance its sealing effect against the end of a screen assembly. The top part 241c of the seal holder 240 projects into a recess 246 formed between the lip 244 and the body 243 of the seal 242. This assists in maintaining the seal 242 in a desired position with respect to the end of a screen assembly.

FIG. 20H shows a seal holder 247 according to the present invention which has a lower part 247a, an upright part 247b, and an inclined part 247c projecting upwardly. A seal 248 has a body 248a releasably and removably disposed in an interior area of the seal holder 247. Optionally, the body 248a is hollow as shown (or it may be solid). A lip 249 is connected to or formed integrally of a projecting part 248b. The projecting part 248b is connected to or formed integrally of the body 248a. The seal holder 247 can be used in a vibratory separator or shale shaker as the seal holder 222, FIG. 18, is used. Preferably the shape of the interior space of the seal holder 247 and of the major portion of the body 248a of the seal 247 are substantially the same. The lip 249 is optional. Preferably the seal 282 is flexible to enhance its sealing effect against the end of a screen assembly. The inclined part 247c of the seal holder 247 projects into a recess 248c formed between a lower part 248d of the lip 249 and the body 248a of the seal 248. This assists in maintaining the seal 248 in a desired position with respect to the end of a screen assembly. In one aspect the lip 249 is flexible with respect to the projecting part 248b and can move backwardly (to the left in FIG. 20H) to accommodate a screen assembly end and/or to enhance sealing contact therewith.

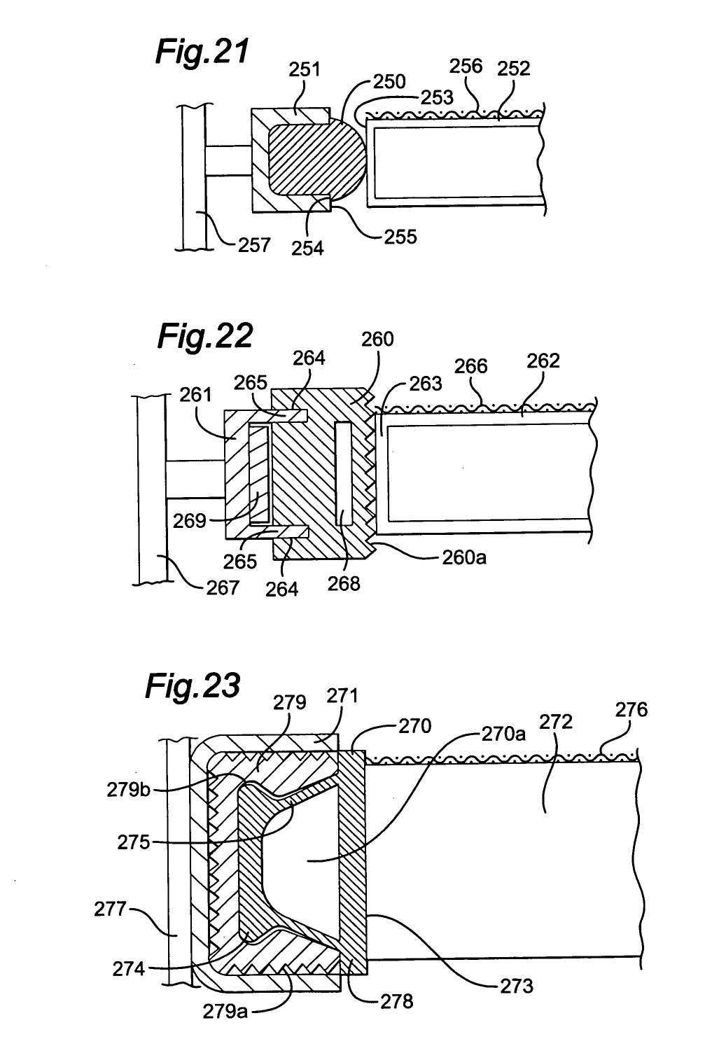

FIG. 21 shows a seal 250 removably mounted in a seal holder 251 with a screen assembly 252 (shown schematically) having an end 253 sealingly contacting the seal 250. The seal 250 has a lip 254 that abuts an exterior surface 255 of the seal holder 251. The seal holder 251 is positioned, e.g., as is the seal holder 222. The screen assembly 252 has screening material 256. The seal 250 is of a length substantially equal to or slightly larger than a length of the end 253. The seal holder 251 is secured to, connected to, or formed integrally of a side wall 257 of a basket or other screen supporting structure of a separator or shaker.

FIG. 22 shows a seal 260 removably mounted to a seal holder 261 with a screen assembly 262 (shown schematically) having an end 263 sealingly contacting the seal 260. The seal 260 has recesses 264 that receive portions 265 of the seal holder 261. The seal holder 261 is positioned, e.g., as is the seal holder 222. The screen assembly 262 has screening material 266. The seal 260 is of a length substantially equal to or slightly larger than a length of the end 263. The seal holder 261 is secured to, connected to, or formed integrally of a side wall 267 of a basket or other screen supporting structure of a separator or shaker. Optionally, the seal 260 has a void space 268 which enhances seal/screen assembly contact and, also optionally, a corrugated surface 260a for contacting the screen end 263. Optionally a member 269 may be permanently or removably positioned within the seal holder 261 to serve as a space maintainer, shock absorber, cushion, and/or seal and may be made of any suitable plastic, metal, composite, fiberglass, alloy or seal material.

FIG. 23 shows a seal 270 removably mounted in a seal holder 271 with a screen assembly 272 (shown schematically) having an end 273 sealingly contacting the seal 270. The seal 270 has a lip 274 that abuts a surface 275 of a seal holder 279. The seal holder 279 is removably or permanently positioned within a seal holder 271 which is positioned, e.g., as is the seal holder 222. The screen assembly 272 has screening material 276. The seal 270 is of a length substantially equal to or slightly larger than a length of the end 273. The seal holder 271 is secured to, connected to, or formed integrally of a side wall 277 of a basket or other screen supporting structure of a separator or shaker. The seal holder 279 may be made of any material mentioned above for the member 269. Optionally the seal holder 279 may have a corrugated outer surface 279a to facilitate its movement within the seal holder 271. A recess 279b receives a lip 274 of the seal 270. A wall 275 connects the lip 274 to an outer part 278 of the seal 270. Optionally, the seal 270 has an inner void space 270a.

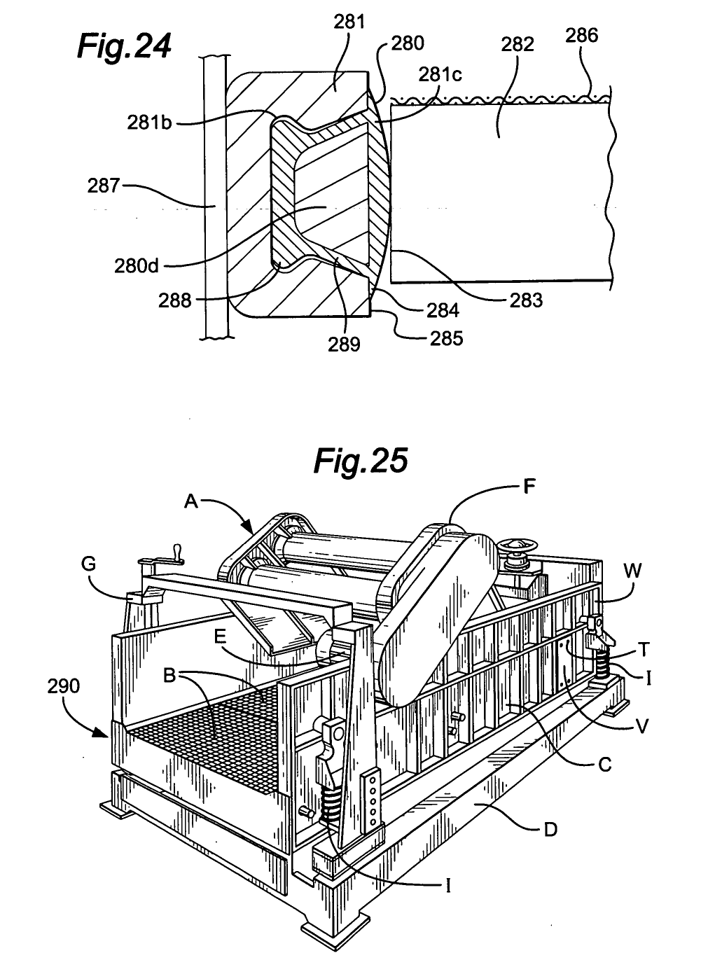

FIG. 24 shows a seal 280 removably mounted in a seal holder 281 with a screen assembly 282 (shown schematically) having an end 283 sealingly contacting the seal 280. The seal 280 has a lip 284 that abuts an exterior surface 285 of the seal holder 281. The seal holder 281 is positioned, e.g., as is the seal holder 222. The screen assembly 282 has screening material 286. The seal 280 is of a length substantially equal to or slightly larger than a length of the end 283. The seal holder 281 is secured to, connected to, or formed integrally of a side wall 287 of a basket or other screen supporting structure of a separator or shaker. A recess 281b receives a lip 288 of the seal 280. A wall 289 connects the lip 281b to an outer part 281c of the seal 280. A rigid member 280d extends throughout the length of the seal 280 to provide strength and rigidity. Any seal or seal member according to the present invention may have a rigid member like the rigid member 280d of a cross-sectional shape similar to or different than that of the rigid member 80d (e.g., oval, circular, square).

The seal holders of FIGS. 21-24 have a length corresponding to the length of the seals mounted therein or thereto (e.g. slightly shorter, slightly larger or similar to that of the seal holder 222).

FIG. 25 shows a shale shaker A according to the present invention with screens B (with screen or screening cloth or mesh as desired) mounted on the vibratable screen mounting apparatus or basket C. The screens B may be any screen disclosed or referred to herein or have any combination of any feature or features of any screen or screen part disclosed herein. The basket C is mounted on springs I (only two shown; two as shown are on the opposite side) which are supported from a frame D. The basket C is vibrated by a motor E and interconnected vibrating apparatus F which is mounted on the basket C for vibrating the basket and the screens. Elevator apparatus G provides for raising and lowering of the basket end.

An access cover V is removably secured with bolts T over an opening through a wall W of the basket C for providing access to seal structure (not shown, like any discussed above) which seals a screen/basket interface within the basket C.

The present invention, therefore, provides, in at least certain embodiments, a support apparatus for supporting at least one screen assembly of a vibratory separator, the vibratory separator having seal apparatus for sealing an interface between a portion of the at least one screen assembly and an interior surface of the support apparatus, the seal apparatus including a seal member removably held by a seal holder within the vibratory separator, the support apparatus having container apparatus (e.g., but not limited to, a basket of a shale shaker) having a side wall, the side wall having an opening therethrough adjacent an end of the seal apparatus, and a cover movably connected to the side wall on an exterior surface thereof, the cover movable to provide access to the seal apparatus. Such a support may have one or some, in any possible combination, of the following: wherein the at least one screen assembly is two screen assemblies, the vibratory separator apparatus has individual seal apparatus corresponding to each screen assembly, the side wall has an access opening corresponding to each individual seal apparatus, and the side wall has a movable cover over each access opening; a seal holder within the support apparatus for releasably holding the seal member; wherein the seal holder is generally C shaped in cross-section; the seal member, and the seal member has a length and the seal holder has a length at least equal to the length of the seal member; and/or the seal member, the seal member having at least one recess and the seal holder having a projecting part for projecting into the or each of the recesses of the seal member or the seal member having opposed recesses and the seal holder having opposed in-turned edges for projecting into the recesses of the seal member.

The present invention, therefore, provides, in at least certain embodiments, a holder for holding a seal member for sealing an interface with a screen assembly mounted in a vibratory separator, the holder having a solid body (or a body with a hollow interior) for releasably holding part of a seal member, the seal member having at least one recess, the body having at least one projecting part projecting from the body member, the projecting part sized, configured, and positioned for releasable receipt within the at least one recess of the seal member. Such a holder may have a plurality of recesses and the at least one projecting part is a plurality of projecting parts, one projecting part corresponding to each recess.

The present invention, therefore, provides, in at least certain embodiments, a seal (seal structure or seal member) for sealing an interface between a screen assembly and a vibratory separator in which the screen assembly is mounted, the seal having a body, at least one recess in the body, and the at least one recess sized, configured and positioned for releasable receipt therein of part of a seal holder of the vibratory separator. Such a seal may have one or some, in any possible combination, of the following: a projecting portion of the seal projecting from the body and adjacent the at least one recess, the projecting portion for sealingly contacting the screen assembly; and/or wherein the projecting portion includes a main arm projecting from the body, and one lip or two spaced-apart lips projecting from the main arm; wherein the two spaced-apart lips are at a right angle or at an obtuse angle to each other.

The present invention, therefore, provides, in at least certain embodiments, a seal for sealing an interface between a screen assembly and a vibratory separator in which the screen assembly is mounted, the seal having a body, the body having a first end and a second end, the second end spaced-apart from the first end, and a pull apparatus (e.g., but not limited to, a tab, a ring, a projection at a seal end located for pulling) connected to the first end.

The present invention, therefore, provides, in at least certain embodiments, a vibratory separator having a basket (or box or container) for supporting screen assembly apparatus, the basket having a first side wall spaced-apart from a second side wall by two opposed ends, the basket having an interior surface, vibrator apparatus connected to the basket to vibrate the basket and the screen assembly apparatus, screen assembly apparatus releasably secured to the basket, the screen assembly apparatus having an interface portion interfacing with a corresponding part of the interior surface of the basket, seal apparatus connected to the basket for sealing an interface between the interface portion of the screen assembly apparatus and the corresponding part of the interior surface of the basket, the seal apparatus including a seal holder and a seal member releasably held by the seal holder, an access opening through the first side wall adjacent part of the seal apparatus and through which the seal member is accessible and passable, and a cover on an exterior of the first side wall movable with respect to the side wall to provide selective access to the seal apparatus through the access opening. Such a vibratory separator may have one or some, in any possible combination, of the following: wherein the vibratory separator is a shale shaker for treating drilling fluid material from an earth wellbore and the seal member is made of material able to withstand the drilling fluid material; wherein the screen assembly apparatus has at least a first assembly and a second screen assembly, the first screen assembly with at least a portion thereof disposed at a level higher than at least a portion of a level of the second screen assembly, each of the first screen assembly and the second screen assembly having an end portion interfacing a corresponding surface of part of the basket, the seal apparatus including first seal apparatus for the first screen assembly and second seal apparatus for the second screen assembly, each seal apparatus having a seal holder and a seal member, an access opening through the side wall corresponding in position to each seal apparatus, and a cover movably connected over each access opening; wherein the seal holder is generally C-shaped in cross-section; wherein the seal holder has at least one part for projecting into a corresponding recess of the seal member, and the seal member has at least one recess corresponding to each of the at least one part of the seal holder; wherein the seal holder has an outer surface, and the seal member has a portion for sealingly contacting the outer surface; wherein the seal member has a void inner space; wherein the seal member has an inner rigid member; a spacer member within the seal holder between an inner surface of the seal holder and an outer surface of the seal member; wherein the spacer member is made of cushion material; wherein the seal holder has a body with a hollow interior for releasably holding part of the seal member, the seal member having at least one recess, the body having at least one projecting part projecting from the body member, the projecting part sized, configured, and positioned for releasable receipt within the at least one recess of the seal member and/or wherein the seal member has a body, at least one recess in the body, and the at least one recess sized, configured and positioned for releasable receipt therein of part of a seal holder of the vibratory separator.

The present invention, therefore, provides, in at least certain embodiments, a container (e.g. a basket, box, etc.) for a vibratory separator, the container for containing and supporting screen assembly apparatus used with the vibratory separator, the container having spaced-apart walls connected by interconnecting members, the spaced-apart walls having space therebetween for encompassing screen assembly apparatus, the spaced-apart walls including a first wall and a second wall, seal apparatus connected to the first wall of the spaced-apart walls for sealing an interface between the screen assembly apparatus and the first wall, an access opening through the second wall adjacent part of the seal apparatus, and a cover over the access opening, the cover movable with respect to the second wall to provide selective access to the seal apparatus through the access opening.

The present invention, therefore, provides, in at least certain embodiments, methods for treating material with a vibratory separator, the vibratory separator as any disclosed herein according to the present invention, the methods including activating the vibratory separator, introducing material to be treated (e.g., but not limited to, drilling fluid from a wellbore with solids entrained therein) to the vibratory separator, and screening the material so that part thereof passes through the screen assembly apparatus. Such methods may have one or some, in any possible combination, of the following wherein the seal member is accessed without removing the screen assembly apparatus from the vibratory separator; and/or deactivating the vibratory separator, and moving the cover to access the seal member.

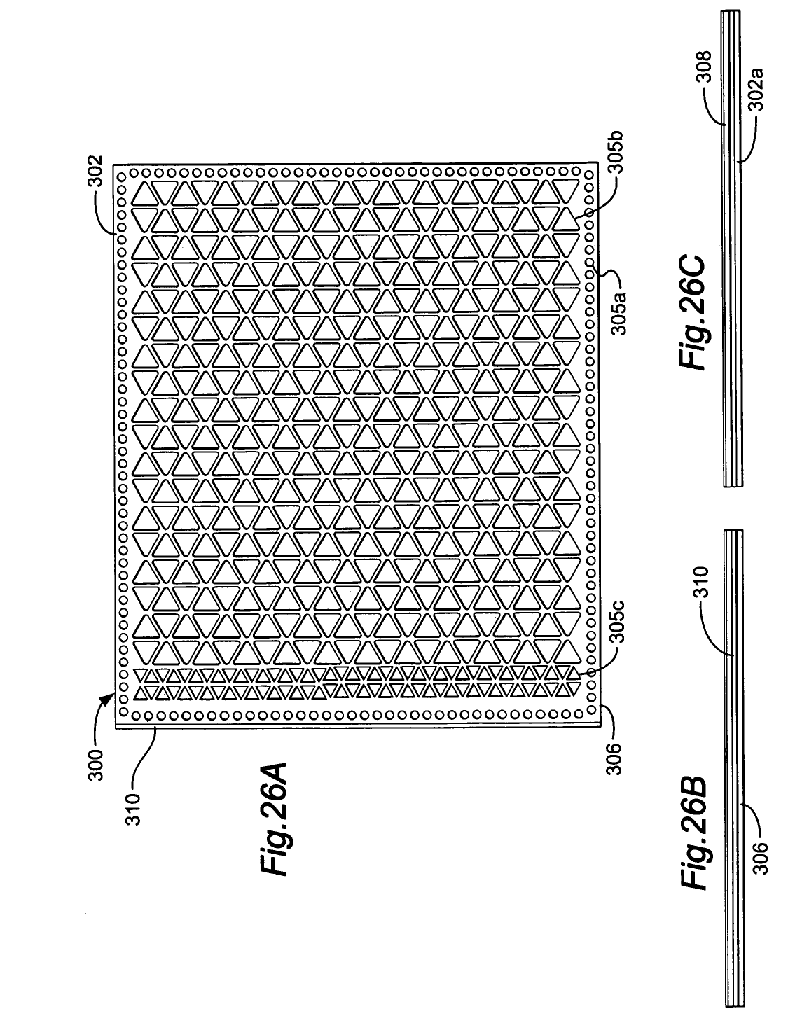

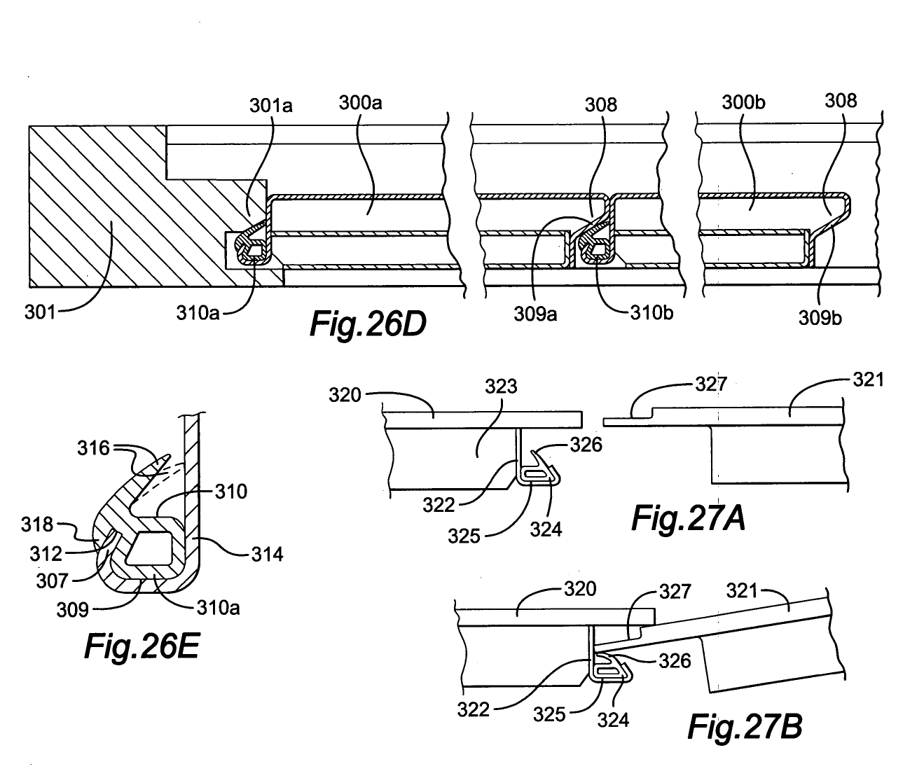

FIGS. 26A-26C show a screen assembly 300 according to the present invention which has a support 302 for screen material. The support 302 has a plurality of different openings 305a, 305b, 305c therethrough, but it is to be understood that the support 302 may be any known support or frame or part thereof used to support screen material in a screen assembly. The pattern and size of the openings in the support 302 are disclosed in pending U.S. application Ser. No. 10/036,742 filed Dec. 21, 2001, co-owned with the present invention and fully incorporated here for all purposes. The support 302 has an end shoulder 302a.

A seal holder 314 removably holds a seal 310. The seal holder is formed of or connected to an end of the screen assembly 300. An end 308, spaced-apart from the end 306, has a shoulder like the shoulder 309a. The seal holder 314 has a part 307 that projects into a recess 312 of the seal 310.

The seal 310 has a body 304 with an optional hollow center that extends along the entire length of the seal 310. The seal 310 is, in certain aspects, substantially as long as the end 306 of the screen assembly 300 and, in one particular aspect is as long as the seal member 330 and may be made of any of the materials used for the seal member 330 and of a similar hardness.

The seal member 310 has two lips 316 and 318. Part of the exterior of the body 304 and a lower surface of the lip 318 define the recess 312. In certain aspects the seal 310 is made of flexible seal material so that the body 304 is flexible to facilitate insertion of the body 304 into a recess 309 of the seal holder 314 and so that the lip 316 can flex to a position shown by the dotted line in FIG. 26E when the seal 310 abuts part of a shaker or separator, or an end or shoulder of an adjacent screen assembly (like the shoulders shown in FIG. 26D) to facilitate sealing of the interface between two adjacent screen assemblies.

FIG. 26D shows two screen assemblies 300a, 300b (like the screen assembly 300) in abutting relationship to a shale shaker basket 301. A seal 310a of the screen assembly 300a seals a basket/screen-assembly interface where the screen assembly 300a has an end adjacent a shoulder 301a of the shale shaker basket 301. A seal 310b of the screen assembly 300b seals a screen-assembly-300a/screen-assembly-300b interface. The screen assembly 300a has a shoulder 309a and the screen assembly 300b has a shoulder 309b, both like the shoulder of the screen assembly 300.

FIGS. 27A and 27B show screen assemblies 320, 321. It is to be understood that screen assembly 321, shown partially, has an end (not shown) like the end that is shown of the screen assembly 320; and the screen assembly 320 has an end (not shown) like the end that is shown of the screen assembly 321. A seal holder 322 formed of or connected to a body 323 of the screen assembly 320 releasably holds a seal 324 in a recess 325 of the seal holder 322. Optionally the seal 324 has a hollow center. The seal 324 may have dimensions like the seal 310 or the seal member 330 described above and may be made of the material used for them.

The seal 324 has a flexible projection 326 which can flex as shown in FIG. 27B when contacted by an end 327 of the screen assembly 321, thus sealing the interface between the two screen assemblies.

Any of the seals in FIGS. 26E and 27A may have a pull apparatus like that of the seal member 330.

The present invention, therefore, provides, in at least some and not necessarily all embodiments, a screen assembly for use in a vibratory separator, the screen assembly having a body, the body having a first end and a second end, the second end spaced-apart from the first end, a seal, a seal holder on the first end of the body holding the seal, the seal having a recess and the seal holder having a projection for projecting into the recess of the seal. Such a screen assembly may have one or some, in any possible combination, of the following: the seal having a hollow interior along substantially all of its length or spaced-apart hollow portions; wherein the seal is for sealing an interface between a screen assembly and a vibratory separator in which the screen assembly is mounted; wherein the seal is for sealing an interface between the screen assembly and an adjacent screen assembly; wherein the seal is positioned to seal both of a screen-assembly/vibratory-separator interface or to seal an interface between the screen assembly and an adjacent screen assembly depending on where it is installed in a separator or shaker; wherein the seal includes a main body, and one lip or two spaced-apart lips connected to the main body; wherein the seal has a body and a lip connected to the body, the lip flexible for flexing upon contact with another member to facilitate sealing of an interface between the screen assembly and the another member; and/or wherein the seal has a pull apparatus connected to an end thereof or to both ends thereof.

The present invention, therefore, provides, in at least some and not necessarily all embodiments, a holder for a screen assembly for use in a vibratory separator, the holder for holding a seal member for sealing an interface of the screen assembly with the vibratory separator or an interface between the screen assembly and an adjacent screen assembly, the holder having a body with an interior for releasably holding part of a seal member, the seal member having at least one recess, the body having at least one projecting part projecting from the body member, the projecting part sized, configured, and positioned for releasable receipt within the at least one recess of the seal member; and such a holder wherein the seal has a length and the seal holder has a length substantially equal to the length of the seal.

The present invention, therefore, provides, in at least some and not necessarily all embodiments, a vibratory separator having a basket for supporting screen assembly apparatus, the basket having a first side wall spaced-apart from a second side wall by two opposed ends, the basket having an interior surface, vibrator apparatus connected to the basket to vibrate the basket and the screen assembly apparatus, screen assembly apparatus releasably secured to the basket, the screen assembly apparatus having an interface portion interfacing with a corresponding part of the interior surface of the basket, the screen assembly apparatus having a screen assembly body with a first end and a second end, the second end spaced-apart from the first end, seal apparatus connected to the screen assembly apparatus for sealing an interface between a portion of the screen assembly apparatus and a part of the interior surface of the basket, the seal apparatus comprising first seal apparatus including a first seal holder and a first seal member held by the first seal holder, the first seal holder on the first end of the screen assembly body, and the first seal member having a recess and the first seal holder having a projection for projecting into the recess. Such a vibratory separator may have one or some, in any possible combination, of the following: wherein the vibratory separator is a shale shaker for treating drilling fluid material from an earth wellbore and the seal member is made of material able to withstand the drilling fluid material; wherein the screen assembly apparatus has at least a first screen assembly and a second screen assembly, the first screen assembly abutting the second screen assembly, the first seal apparatus on the first screen assembly, the seal apparatus further comprising second seal apparatus on the second screen assembly, the second seal apparatus for sealing an interface between the first screen assembly and the second screen assembly, the second seal apparatus having a second seal member releasably held by a second seal holder, and second seal member having a second recess and the second seal holder having a projection for projecting into the second recess; wherein the first and/or second seal holder has an outer surface, and wherein the corresponding seal member has a portion for sealingly contacting the outer surface; wherein one or each seal member has a void inner space; and/or wherein each seal holder has a body with a hollow interior for releasably holding part of a corresponding seal member.

The present invention, therefore, provides, in at least some and not necessarily all embodiments, a method for treating material with a vibratory separator, the vibratory separator as any described herein according to the present invention, the method including activating the vibratory separator, introducing material to be treated to the vibratory separator, and screening the material so that part thereof passes through the screen assembly apparatus. In such a method the vibratory separator may be a shale shaker for treating drilling fluid with solids entrained therein.

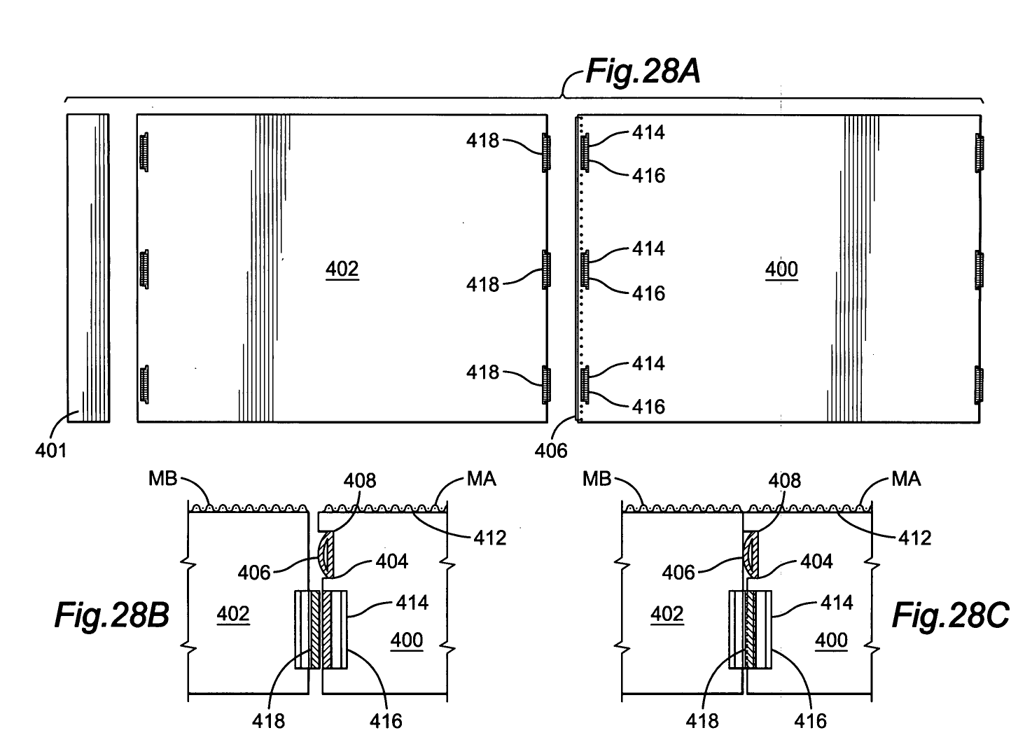

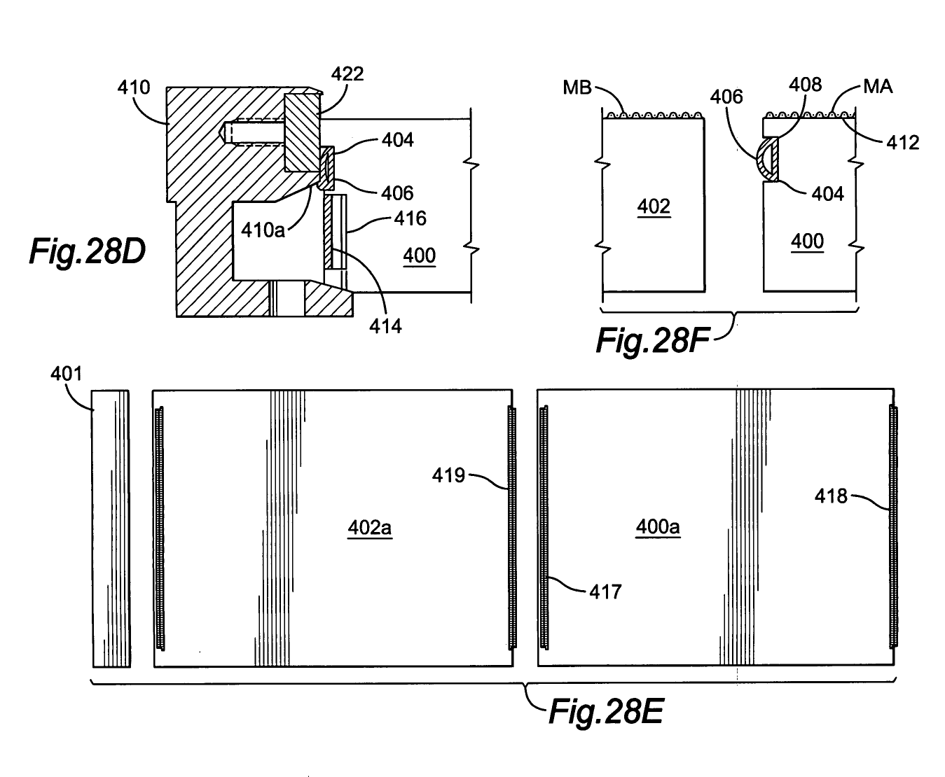

FIGS. 28A-38F illustrate various screens, seals, and fasteners for connecting screens according to the present invention. It is to be understood that any fastener material piece (singly, two, three, four or more) disclosed in these figures can be used on any screen or screens for vibratory separators and shale shakers and on any screen or screens disclosed herein (with or without any seal disclosed herein). Similarly it is to be understood that any seal disclosed in these figures can be used on any screen or screens for a vibratory separator or shale shaker and on any screen or screens disclosed herein (with or without any material piece or fastener disclosed herein). It is to be understood that any screen or screen assembly disclosed in FIGS. 28A-38F can have any known screen mesh or screening material layer or layers (e.g., but not limited to, the mesh MA or the mesh MB, FIG. 28B or the mesh M, FIG. 34) with multiple layers connected together in any known manner, including but not limited to, any screening material, mesh, layer or layers referred to herein; and that any known screen support and/or side mounting structure may be used with such screens.

FIGS. 28A, 28B, and 28C show a first screen assembly 400 connectible to a second screen assembly 402. The screen assembly 400 has a seal recess 404 which is located a seal 406 for sealingly abutting part of the screen assembly 402. In one aspect the recess 404 and the seal 406 are sized so that when the screen assembly 400 abuts the screen assembly 402, there is, as shown in FIG. 28C, no space between the two screen assemblies while the seals 406 sealingly contact the screen assembly 402. The screen assembly 400 has screen mesh MA thereon and the screen assembly 402 has the screen mesh MB thereon. Any screen or screen assembly in FIGS. 28A-38F may have such a mesh MA or MB. The mesh MA, the mesh MB, and/or the mesh M (FIG. 34) can indicate any known mesh or screening material, or any known layers of screening material, connected together or not. The screen 402 can, optionally, abut a part 401 of a separator or shaker. The seal 406 may be solids. As shown, it is hollow along its length.

It is within the scope of this invention to use one, two, three, four or more recess-seal combinations (any disclosed herein) on a screen assembly (any disclosed herein) and the recess and seal can be of any desired dimensions; in one aspect the seal (any disclosed herein) when in place in a recess (any disclosed herein) and abutting an adjacent screen assembly is about ⅜″ inches in height (as viewed in FIG. 28B).

In one aspect the top edge 408 of the recess 404 is as close to a top 412 of the screen assembly 400 as possible (as may be in any screen or screen assembly disclosed herein) to enhance the sealing effect and to minimize any leakage path between the screen assemblies. In certain particular aspects, this distance is about ⅛ to ¼ inches. As is true of any seal herein, the seal 406 may extend along substantially all of the length of the end of the screen assembly 400.

The screen assembly 400 has a piece or pieces 414 of releasably-cooperating material (e.g. lockable stem material or hook-and-loop fastener material, henceforth “RCM” material) positioned in corresponding recesses 416. Mating pieces 418 of RCM material are secured to the screen assembly 402. It is within the scope of the present invention to use one, two, three, four or more combinations of RCM material on adjacent screen assemblies. The piece or pieces of RCM material (as is true for any disclosed herein) may be of any desired size and shape, but are of sufficient size that when two adjacent screen assemblies are releasably connected therewith, moving or pulling on one of the screen assemblies results in moving or pulling of the other screen assembly along with the screen assembly being pulled.

In one aspect the recesses 416 are sized (as may be any recess disclosed herein) so that when the pieces of RCM material are interconnected, all or substantially all of the material is within the recess (e.g. as shown in FIG. 28C) so that the adjacent screen assemblies can abut each other with no or minimal space therebetween; i.e., so that the RCM material does not interfere with sealing contact or with screen assembly abutment.

As may be for any screen or screen assembly according to the present invention, RCM material may be located above or below a seal or both above and below a seal. Similarly, a seal can be used below RCM material.

FIG. 28D shows a screen assembly 400 with an end adjacent part of a vibratory separator or shaker 410. The seal 406 sealingly abuts part of the separator or shaker 410. In one aspect the separator or shaker 410 has a seal 422 which the seal 406 abuts. In one aspect the seal 422 is a VITON (Trademark) material seal. It is within the scope of the present invention for the seal 406 and the screen assembly 400 (as is true for any seal and any screen assembly according to the present invention) to be used with a separator or shaker 410 as shown or with any known separator or shaker which uses any screen or any screen assembly disclosed or referred to herein. In the situation shown in FIG. 28D, the RCM material 414 and the recess 416 are optional. In the screen assembly 400 (as is true of any screen assembly according to the present invention) either the seal 406 (and recess 404) or the RCM material 414 (and recess 416) can be omitted. Optionally, the seal 422 is deleted.

FIG. 28E shows a screen assembly 400a, like the screen assembly 400, but with a single amount of RCM material 417 and a screen assembly 402a like the screen assembly 402, but with a single amount of RCM material 419 corresponding in length to and for engaging the material 417. Recesses like these described herein may be used for the material 417, 419 and, optionally, the other ends of the screen assemblies may also have RCM material (“RCM”) so that any two ends of the screen assemblies may be connected end to end.

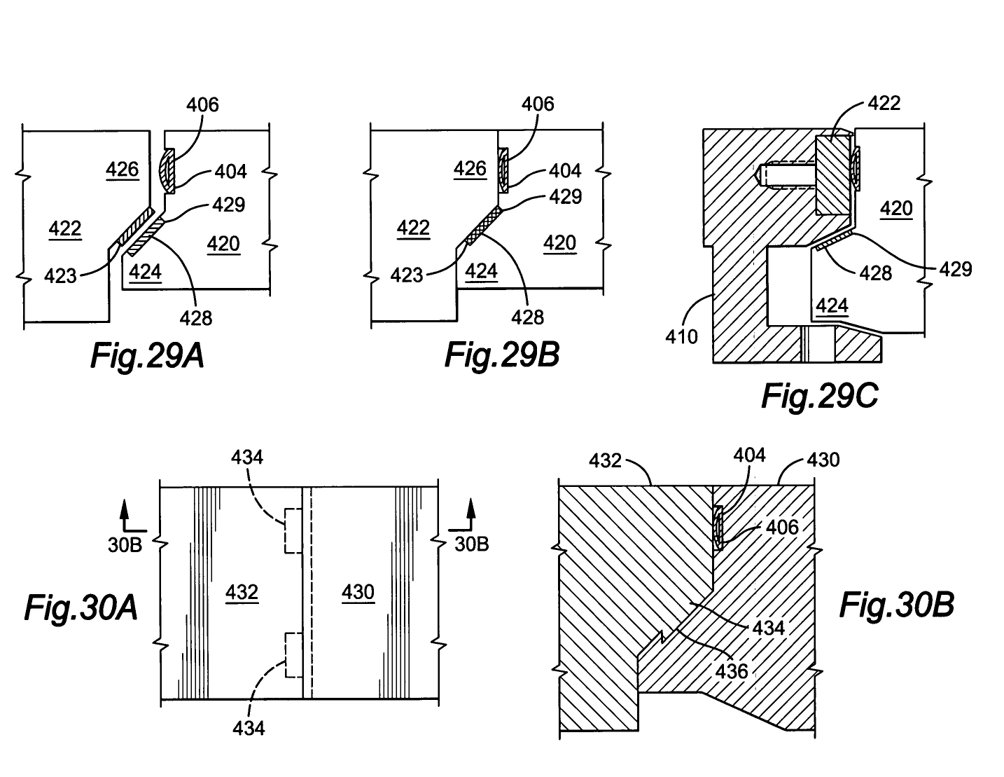

FIGS. 29A-29C illustrate screen assemblies according to the present invention which have a lower projecting portion with an amount of RCM material for connecting to an adjacent screen assembly. As shown in FIGS. 29A and 29B a first screen assembly 420 is used with a second screen assembly 422. The screen assembly 420 has a projecting part 424 which projects under an upper part 426 of the screen assembly 422. A seal 406 (as described above) in a recess 404 (as described above for the screen assembly 400) sealingly abuts part of the screen assembly 422.

The screen assembly 420 has an amount 428 of RCM material in a recess 429 and the screen assembly 422 has a corresponding amount 423 of RCM material for releasably mating with the material 429. Optionally, as with the screen assembly 400, one, two, three or more combinations of corresponding amounts of RCM material may be used with the screen assemblies 420, 422.

FIG. 29C shows the screen assembly 420 used with a separator or shaker 410 (like the shaker 410, FIG. 28D).

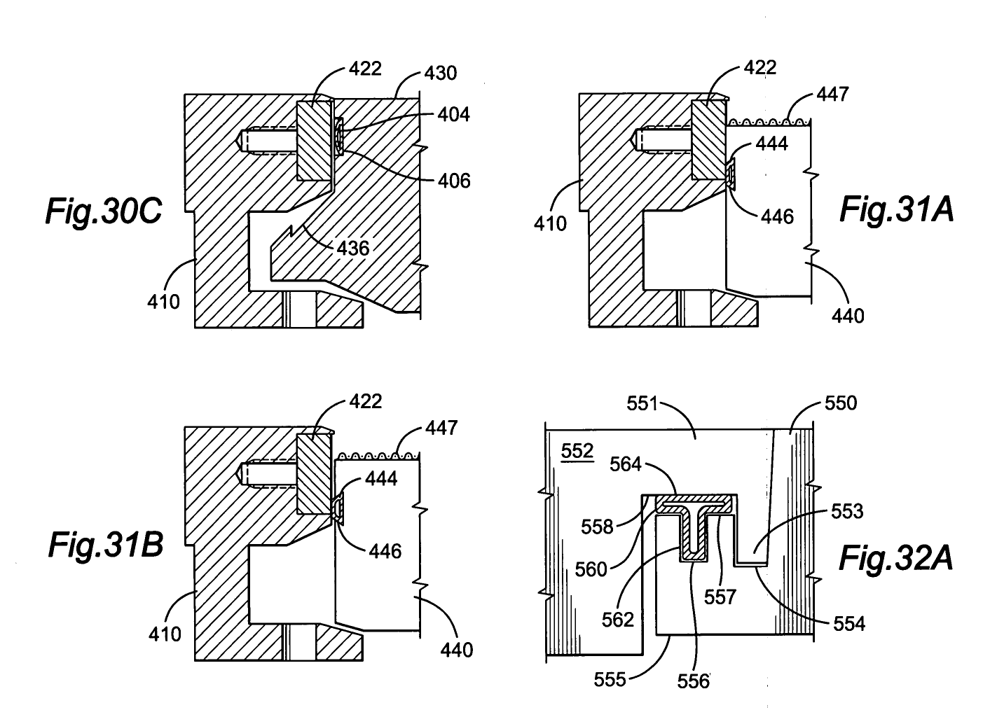

FIGS. 30A and 30B show two interconnected screen assemblies 430 and 432. Pins 434 of the screen assembly 432 are received in and held releasably in corresponding recesses 436 in a projecting portion 438 of the screen assembly 430. A seal 406 in a recess 404 (as described above) sealingly abuts a portion of the screen assembly 432. Pulling or moving either screen pulls or moves the other screen. Optionally, only one pin 434 and one recess 436 are used; e.g. centrally located; or three, four or more such pins and recesses are used.

FIG. 30C shows the screen assembly 430 abutting part of a separator or shaker 410 (as described above). Optionally, the seal 422 is deleted (as can be done with any shaker 410 herein) and the void left by it is either filled in with any desirable material or the separator or shaker is made with no such void space.

FIG. 31A illustrates a screen assembly 440 with a seal 446 in a dovetail shaped recess 444. The screen assembly 440 may abut an adjacent screen or, as shown, may abut part of a separator or shaker 410 (as described above). FIG. 31B shows the seal 446 expanded and not yet compressed against the shaker 410. Mesh 447 (like any mesh disclosed or referred to herein, e.g. mesh M, MA or MB) is on top of the screen assembly 440. As may be the case with any seal herein, the seal 446 may be held in its recess by a friction fit and/or with any suitable glue or adhesive, e.g. but not limited to cyanoacrylic glue. Any seal disclosed herein may be positioned in a dovetail recess as shown in FIG. 31A.

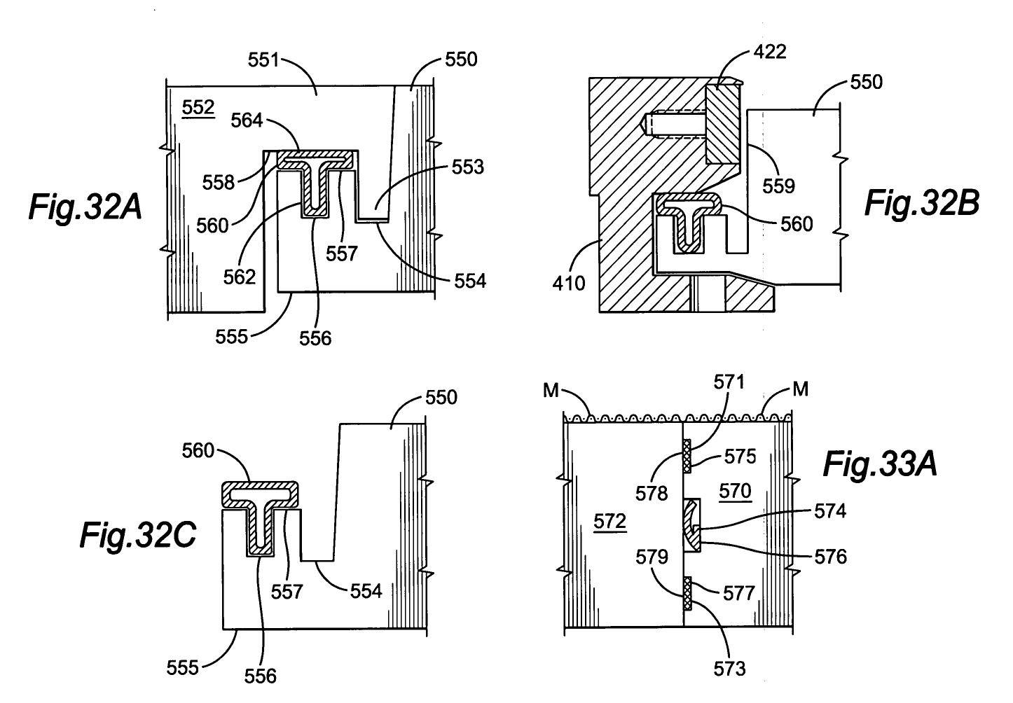

FIG. 32A shows two interconnected screen assemblies 550 and 552. The screen assembly 552 has a lip, shoulder, part, ledge or rim 551 which has a downwardly projecting finger 553 which has an end that is received in and held releasably in a recess 554 formed in a projection 555 of the screen assembly 550.

A seal 560 has a portion 562 received in and held in a recess 556 in the projection 555 of the screen assembly 550. The abutment of the finger 553 against the bottom of the recess 554 prevents a top surface 557 of the projection 555 from contacting a bottom surface of the lip 551 so that a space is provided therebetween for a portion 564 of the seal 560. The seal 560 seals an interface between the two screen assemblies 550, 552. The seal 560 (as may be any seal herein) may be solid; but as shown it is hollow along its length.

FIG. 32B shows a screen assembly 550 abutting part of a separator or shaker 410 (as described above) with the seal 560 sealingly contacting the separator or shaker 410. Optionally a top part 559 of the screen assembly 550 may abut the separator or shaker 410 (e.g. as the screen assembly 550 abuts the screen assembly 551 in FIG. 32A). Optionally, the seal 560 is deleted.

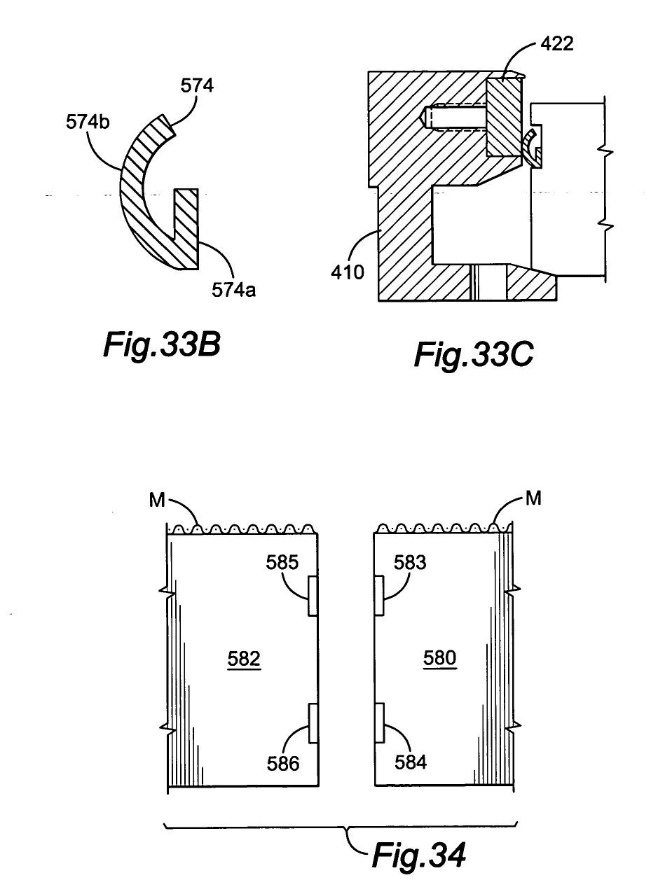

FIG. 33A shows two releasably interconnectible screen assemblies 570 and 572 each with screen mesh M (like any mesh disclosed herein). A seal 574 (see FIG. 33B) in a recess 576 is located for sealingly contacting the screen assembly 572. Optionally, any seal disclosed herein may be used instead of the seal 574. Amounts 571, 573 of RCM material in corresponding recesses 575, 577, respectively, are releasably connectible to corresponding amounts 578, 579, respectively, of RCM material secured, respectively, to the screen assembly 572. Any seal or amount of RCM material in any screen assembly according to the present invention may be secured in place with any suitable adhesive, screw, bolt, rivet, and/or fastener. A curved part 574b of the seal 574 has one free end and one end connected to a seal part 574a so that the curved part can move with respect to the part 574a. Thus when the screen assembly 570 is moved against the screen assembly 572, the curved part 574b can sealingly contact the screen assembly 572 and the two screen assemblies can still move into contact with each other.

FIG. 33C shows the screen assembly 570 for use with a separator or shaker 410 (as described above).

It is within the scope of the present invention for a seal on a screen assembly (any seal disclosed herein) to be of such dimensions that it contacts and seals against only a seal (e.g. such as the seal 422 of a separator or shaker); or, e.g. as shown in FIGS. 28D, 29C, 30C, and 33C, the seal on the screen assembly can be of such dimensions that it seals against both a seal and a structural part (e.g. the part 410a, FIG. 28D) of a separator or shaker. Two, three, four or more seals (any seal according to the present invention), vertically spaced apart, may be used with any screen assembly herein.

FIG. 34 shows two interconnectible screen assemblies 580 and 582 each of which has one, two, three, four or more magnets 583-586 (two shown on each screen assembly). A magnet or magnets of sufficient strength are used so that moving or pulling of a screen assembly magnetically releasably attached to an adjacent screen assembly (to magnets on the adjacent screen assembly or to metal on the adjacent screen assembly) results in moving or pulling of the adjacent screen assembly.

In certain aspects, with any screen assembly according to the present invention which has a seal which can abut a separator or shaker, no seal (e.g. as the seal 422, FIG. 28D) is used on the separator or shaker and the area occupied by the seal is any desirable material or simply an integral part of the metal structure of the separator or shaker.

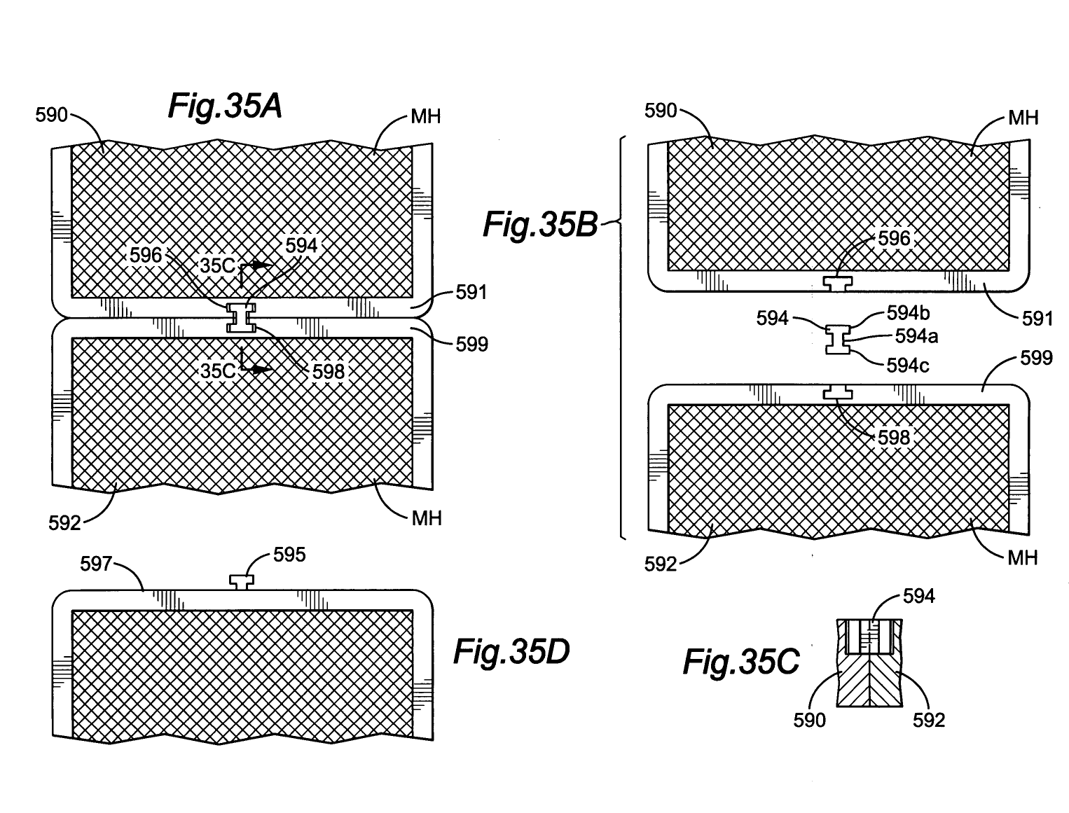

FIGS. 35A-35D show two screen assemblies 590 and 592 releasably interconnected by a connector 594 which is releasably received in and held in recesses 596, 598 in ends 591, 599, respectively of the screen assemblies 590, 592, respectively. Such a recess may be provided at both ends of a screen assembly. The connector 594 has a base 594a and two ends 594b and 594c. The ends 594b and 594c have a dimension larger than the width of the base 594a so that, with the connector 594 inserted into the recesses 596, 598, pulling on one of the screen assemblies 590, 592 results in moving of the other screen assembly.

The connector 594 may be sized (as may be the case for any connector disclosed herein for screen assemblies according to the present invention) so that a portion of it projects above the screen assemblies 590, 592; or, as shown in FIGS. 35A and 35C, it may be sized (as may be the case for any connector disclosed herein for screen assemblies according to the present invention) so its top surface is flush with the top surfaces of the screen assemblies. The screen assemblies 590, 592 have a mesh MH thereacross (like any mesh or meshes disclosed herein).

Optionally, a projecting part 595, like part of the connector 594, is formed integrally of a screen assembly 597 according to the present invention, which is like the screen assemblies 590, 592, but with a recess for a connector at the end with the part 595. The opposite end of the screen assembly 597 (not shown) may have a recess like the recess 596.

The connector 594 may be held within the recesses 596, 598 with a friction fit and/or with a suitable adhesive or glue. Optionally, each screen assembly end is provided with multiple (two, three, or more) recesses and multiple corresponding connectors are used (as may be the case with any connector-recess combination for any screen assembly according to the present invention). Optionally, the connector 594 is somewhat loose within the recesses 596, 598 (the recesses are sufficiently large to achieve this looseness, but not so large that the connector is easily dislodged) to permit some limited freedom of movement of one screen assembly with respect to the other. The connector 594 (as may be any connector disclosed herein) may be made of plastic, metal, fiberglass, wood, steel, stainless steel, PTFE, or composite material.

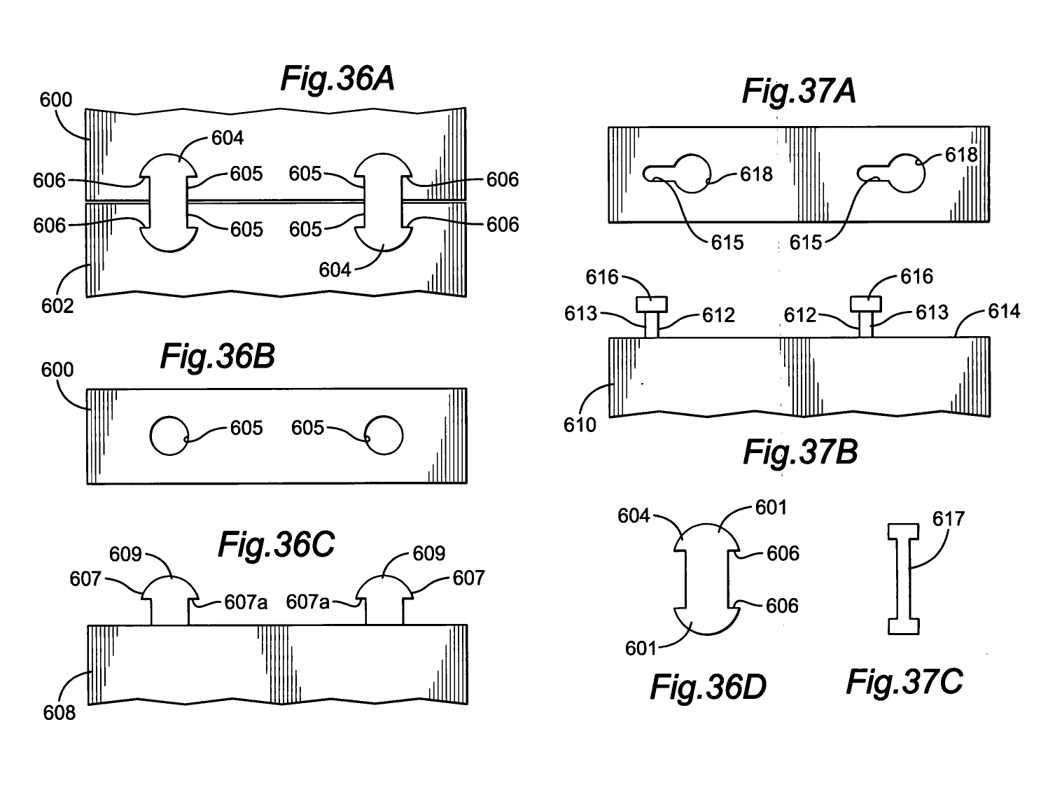

FIGS. 36A and 36B show screen assemblies 600 and 602 according to the present invention each of which has holes 605 in an end thereof into which are releasably inserted connectors 604. Connectors 604, made e.g. of suitable plastic or PTFE, have lips 606 which are sufficiently compressible that the connector lips can be pushed through the holes 605 in each screen assembly and the lips are sufficiently strong that pulling on one screen assembly results in the movement of the other screen assembly rather than the removal of the connector 604 from the adjacent screen assembly's holes by the screen assembly being pulled. Optionally, only one connector-holes combination is used.

Optionally, as shown in FIG. 36C parts of connectors 607 with a lip 607a are formed integrally of an end of a screen assembly 608. Any desired mesh or meshes (not shown) may be used with the screen assemblies 600, 602. The connectors 604 and 607 may be generally cylindrical with bulbous ends 601, 699 respectively; they may have a square cross-section; or they may have any suitably shaped cross-section.

FIG. 37B illustrates a screen assembly 610 according to the present invention which may have any mesh or meshes (not shown) disclosed herein. Projections 612 projecting from the end 614 of the screen assembly 612, like bolt ends or nail ends, are sized so that ends 616 are insertable into holes 618 of an adjacent screen assembly 619. The screen assemblies are then moved together. Then stems 613 of the projections 612 are moved sideways into slots 615 which communicate with the holes 618 (to the left in FIG. 37A) to releasably connect the screen assembly 612 to the screen assembly 619. Pulling on one of the screen assemblies results in movement of the other screen assembly. Moving the screen assembly 610 the other way (to the right in FIG. 37A) results in exposure of the ends 616 in the holes 618 permitting separation of the two screen assemblies. Optionally, only one projection-hole-slot combination is used. The length of the projections 612 can be such that the projections 612 hold the screen assemblies tightly together or such that the projections 612 do not hold the screen assemblies tightly together.

Optionally, adjacent screen assemblies have one, two, three, or more holes 618, slots 615 and separate connectors 617 are used which are releasably insertable into holes on adjacent screen assemblies and selectively movable into and out of the slots 615.

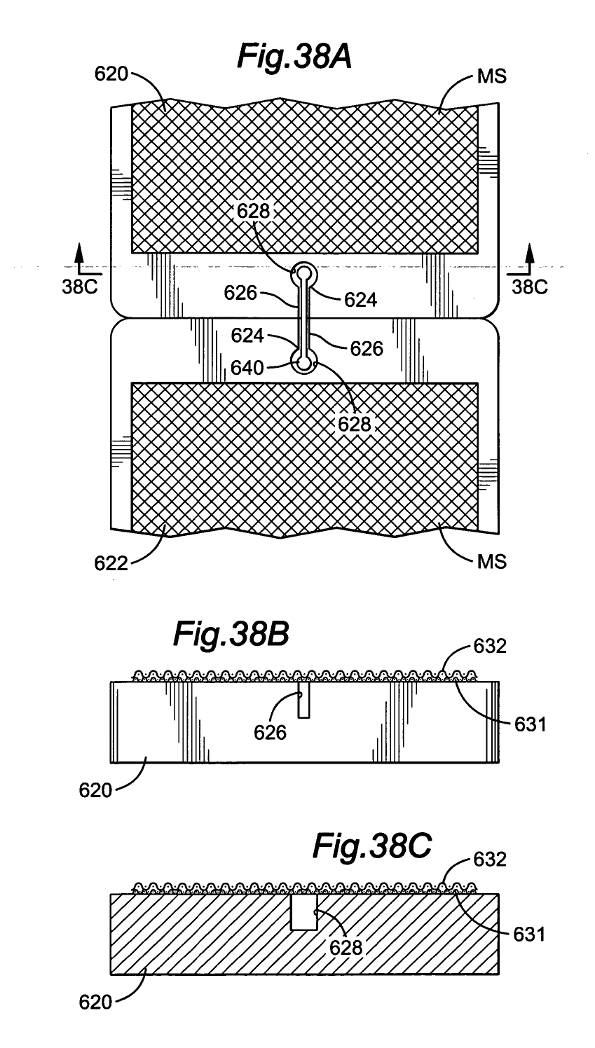

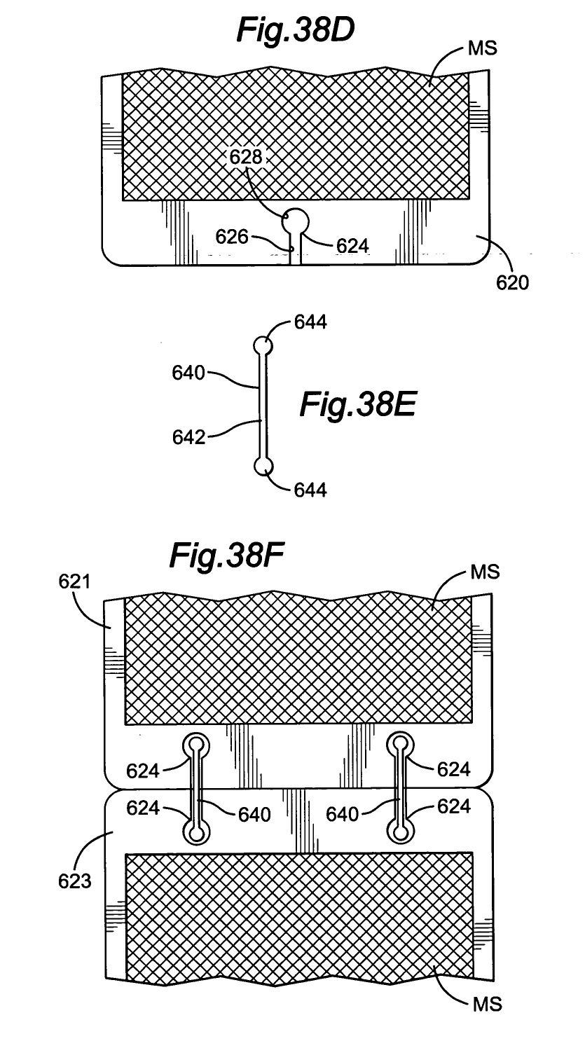

FIGS. 38A-38D show screen assemblies 620 and 622 according to the present invention each of which has mesh MS which is like any mesh disclosed herein. In one aspect as shown in FIGS. 38B and 38C the mesh MS includes (as may be the case with any mesh of any screen assembly herein) two layers of mesh 631, 632 with the mesh layer 632 on top of the mesh layer 631.

Each screen assembly 620, 622 has a recess 624 which is sized for receipt therein of part of a removable connector 640. With the connector 640 installed in both adjacent recesses 624, pulling on one of the screen assemblies results in movement of the other screen assembly. The recesses 624 can be sized and the connector 640 can be sized so that the connector 640 is tightly held around its lateral surfaces within the recesses 624 (as may be the case with any connector-recess or connector-hole structure herein) or the recesses 624 can be sized and the connector 640 can be sized so that the connector 640 holds the screen assemblies 620, 622 tightly together end-to-end (as may be the case, with any connector-recess or connector-hole structure herein); but, as shown in FIGS. 38A-38D, according to the present invention the connector 640 is sized and the recesses 624 are sized so that the connector 640 is positioned loosely within the recesses 624 permitting limited freedom of movement of the screen 620 with respect to the screen 622 when the connector 640 is installed within the recesses 624. This limited freedom of movement (which can be provided with other screen assemblies according to the present invention as described above) facilitates insertion of the connector 640; inhibits undesirable bending or deformation of the screen assemblies during movement; and facilitates removal of the connector from the recesses. Such freedom of movement according to the present invention may be effected with both recesses and all parts thereof sized to provide a loose fit with a connector; or, according to the present invention, only a part of one recess or all of one recess may be sized to achieve the desired looseness and degree of freedom of movement of one screen assembly with respect to the other.

The connector 640 has a stem 642 part of which resides in corresponding parts 626 of the recesses 624 and enlarged ends 644 which reside in corresponding parts 628 of the recesses 624.

Optionally, a screen assembly according to the present invention may have two, three, or more of the connector-640-recess-624 structures (two shown in the screen assemblies 621, 623 of FIG. 38F).

It is to be understood that any screen assembly shown partially in the drawing figures extends to a second end (not shown) like the first end with similar recesses and/or projections; that mesh or meshes cover substantially all of the top of the screen assembly; and that screen assemblies shown with an end having projection(s) have another end without such projection(s) and either with a recess or recesses or with no recesses. By providing screen assemblies with projection(s) at one end and a recess or recesses at the opposite end, any two such screen assemblies can be used end-to-end; or by providing one screen assembly with projection(s) and one screen assembly with a recess or recesses in both ends such end-to-end use is possible.

Any releasably cooperating material and/or recess or recesses disclosed herein may be used with the screen assemblies of FIGS. 30A, 31A, 32A, 33A, 34, 35A, 35D, 36A, 37A, 37B, 38A, 38D, and/or 38F.

The present invention, therefore, provides in some, but not in necessarily all, embodiments a method for manipulating a first screen assembly and a second screen assembly with respect to a screen assembly holding apparatus of a vibratory separator into or onto which the screen assemblies are mountable, the method including: positioning at least a portion of a first screen assembly with respect to screen assembly holding apparatus of a vibratory separator; connecting a second screen assembly to the first screen assembly with releasably cooperating material on each screen assembly; and moving the first screen assembly and the second screen assembly together with respect to the screen assembly holding apparatus, the screen assemblies held together while moving by engagement of the releasably cooperating material on one screen assembly with the releasably cooperating material on the other screen assembly. Such a method may have one or some, in any possible combination, of the following: wherein first and second screen assemblies are insertable into the screen assembly holding apparatus and the method further including moving the first screen assembly to insert the first screen assembly and the second screen assembly into the screen assembly holding apparatus; moving the first screen assembly to remove both the first screen assembly and the second screen assembly from the screen assembly holding apparatus; wherein the first screen assembly includes a seal, the method further including moving the first screen assembly so that the seal sealingly contacts the second screen assembly; wherein the seal has a base and a curved part and has a length and has a generally “D” shaped cross-section and is hollow along its length, the seal's base is disposed in a recess in the first screen assembly, the method further including moving the first screen assembly against the second screen assembly so the curved part of the seal sealingly contacts the second screen assembly; wherein the first screen assembly has a lip projecting therefrom, a lip recess in the lip, the seal is generally “T” shaped with a body with a generally straight base and a generally straight cross member, the body having a length, the body hollow along its length, part of the generally straight base located within the lip recess, the second screen assembly having a seal surface, the method including moving the first screen assembly against the second screen assembly so that the generally straight cross member of the seal sealingly contacts the seal surface of the second screen assembly; wherein the second screen assembly has a finger projecting downwardly therefrom and the first screen assembly has a finger recess for receiving the finger, the method further including inserting the finger into the finger recess; wherein the seal has a base, and a curved portion with a first end and a second end, the first end connected to the base, the second end spaced-apart from and not connected to the base, the method further including moving the first screen assembly against the second screen assembly so that the curved portion of the seal sealingly contacts the second screen assembly and, in doing so, the curved portion moves toward the base; wherein the first screen assembly has a seal recess and a portion of the seal resides in the seal recess; wherein the first screen assembly has a first recess and the releasably cooperating material includes a first piece of releasably cooperating material with part thereof held within the first recess and a second piece of releasably cooperating material on the second screen assembly located for engaging the first piece of releasably cooperating material, the method further including moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly; wherein the first screen assembly has a first inclined end portion, the second screen assembly has a second inclined portion corresponding in inclination to an inclination of the first inclined portion, a first piece of releasably cooperating material on the first inclined portion, a second piece of releasably cooperating material on the second inclined portion, the method further including moving the first screen assembly against the second screen assembly so that the first piece of releasably cooperating material engages the second piece of releasably cooperating material to releasably connect the two screen assemblies together; wherein the first inclined end portion has a first recess and a portion of the first piece of releasably cooperating material is secured in the recess, the method further including moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly; wherein the vibratory separator is a shale shaker for processing drilling fluid with solids entrained therein; wherein the first screen assembly has a first recess in an end thereof, the second screen assembly has a second recess in an end thereof, and a connector is releasably disposable with a first portion thereof in the first recess and a second portion thereof in the second recess, the method further including inserting the first portion of the connector into the first recess and the second portion of the connector into the second recess; and/or wherein at least a part of the connector is held loosely in one or both of the first recess and the second recess permitting freedom of movement of the first screen assembly with respect to the second screen assembly.

The present invention, therefore, provides in some, but not in necessarily all, embodiments a method for manipulating a first screen assembly and a second screen assembly with respect to a screen assembly holding apparatus of a vibratory separator into or onto which the screen assemblies are mountable, the method including: positioning at least a portion of a first screen assembly with respect to screen assembly holding apparatus of a vibratory separator; connecting a second screen assembly to the first screen assembly with releasably cooperating material on each screen assembly; moving the first screen assembly and the second screen assembly together with respect to the screen assembly holding apparatus; wherein the first screen assembly has a first recess and the releasably cooperating material includes a first piece of releasably cooperating material with part thereof held within the first recess and a second piece of releasably cooperating material on the second screen assembly located for engaging the first piece of releasably cooperating material, the method further including moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly, and wherein the vibratory separator is a shale shaker for processing drilling fluid with solids entrained therein.

The present invention, therefore, provides in some, but not in necessarily all, embodiments a method for manipulating a first screen assembly and a second screen assembly with respect to a screen assembly holding apparatus of a vibratory separator into or onto which the screen assemblies are mountable, the method including positioning at least a portion of a first screen assembly with respect to screen assembly holding apparatus of a vibratory separator, the first screen assembly having a first recess and the second screen assembly having a second recess, connecting a second screen assembly to the first screen assembly with a connector, the connector having a first portion in the first recess and a second portion in the second recess, and moving the first screen assembly and the second screen assembly together with respect to the screen assembly holding apparatus; and such a method wherein at least a part of the connector is held loosely in one or both of the first recess and the second recess permitting freedom of movement of the first screen assembly with respect to the second screen assembly.

The present invention, therefore, provides in some, but not in necessarily all, embodiments a pair of connected screen assemblies for use with a vibratory separator, the pair including a first screen assembly, a second screen assembly, the first screen assembly having a first amount of releasably cooperating material secured thereon, the second screen assembly having a second amount of releasably cooperating material secured thereon, and the first amount of releasably cooperating material sufficiently engaging the second amount of releasably cooperating material so that pulling on one of the first or second screen assemblies correspondingly moves the other screen assembly.

The present invention, therefore, provides in some, but not in necessarily all, embodiments a pair of connected screen assemblies for use with a vibratory separator, the pair including a first screen assembly, a second screen assembly, the first screen assembly having a first recess, the second screen assembly having a second recess, a connector with a first portion in the first recess and a second portion in the second recess, and the connector releasably connecting the two screen assemblies so that pulling on one of the first or second screen assemblies correspondingly moves the other screen assembly.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. Any patent or patent application referred to herein is incorporated fully herein for all purposes. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims. All patents referred to herein are incorporated fully herein for all purposes.

What is claimed is:

1. A method for manipulating a first screen assembly and a second screen assembly with respect to a screen assembly holding apparatus of a vibratory separator into or onto which the screen assemblies are mountable, the method comprising
positioning at least a portion of a first screen assembly with respect to screen assembly holding apparatus of a vibratory separator,
connecting a second screen assembly to the first screen assembly with releasably cooperating material on each screen assembly, and
moving the first screen assembly and the second screen assembly together with respect to the screen assembly holding apparatus, the screen assemblies held together while moving by engagement of the releasably cooperating material on one screen assembly with the releasably cooperating material on the other screen assembly.

2. The method of claim 1 wherein first and second screen assemblies are insertable into the screen assembly holding apparatus and the method further comprises
moving the first screen assembly to insert the first screen assembly and the second screen assembly into the screen assembly holding apparatus.

3. The method of claim 1 further comprising
moving the first screen assembly to remove both the first screen assembly and the second screen assembly from the screen assembly holding apparatus.

4. The method of claim 1 wherein the first screen assembly includes a seal, the method further comprising
moving the first screen assembly so that the seal sealingly contacts the second screen assembly.

5. The method of claim 4 wherein the seal has a base and a curved part and has a length and has a generally “D” shaped cross-section and is hollow along its length, the seal's base is disposed in a recess in the first screen assembly, the method further comprising
moving the first screen assembly against the second screen assembly so the curved part of the seal sealingly contacts the second screen assembly.

6. The method of claim 4 wherein the first screen assembly has a lip projecting therefrom, a lip recess in the lip, the seal is generally “T” shaped with a body with a generally straight base and a generally straight cross member, the body having a length, the body hollow along its length, part of the generally straight base located within the lip recess, the second screen assembly having a seal surface, the method comprising
moving the first screen assembly against the second screen assembly so that the generally straight cross member of the seal sealingly contacts the seal surface of the second screen assembly.

7. The method of claim 6 wherein the second screen assembly has a finger projecting downwardly therefrom and the first screen assembly has a finger recess for receiving the finger, the method further comprising
inserting the finger into the finger recess.

8. The method of claim 4 wherein the seal has a base, and a curved portion with a first end and a second end, the first end connected to the base, the second end spaced-apart from and not connected to the base, the method further comprising
moving the first screen assembly against the second screen assembly so that the curved portion of the seal sealingly contacts the second screen assembly and, in doing so, the curved portion moves toward the base.

9. The method of claim 4 wherein the first screen assembly has a seal recess and a portion of the seal resides in the seal recess.

10. The method of claim 1 wherein the first screen assembly has a first recess and the releasably cooperating material includes a first piece of releasably cooperating material with part thereof held within the first recess and a second piece of releasably cooperating material on the second screen assembly located for engaging the first piece of releasably cooperating material, the method further comprising
moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly.

11. The method of claim 1 wherein the first screen assembly has a first inclined end portion, the second screen assembly has a second inclined portion corresponding in inclination to an inclination of the first inclined portion, a first piece of releasably cooperating material on the first inclined portion, a second piece of releasably cooperating material on the second inclined portion, the method further comprising
moving the first screen assembly against the second screen assembly so that the first piece of releasably cooperating material engages the second piece of releasably cooperating material to releasably connect the two screen assemblies together.

12. The method of claim 11 wherein the first inclined end portion has a first recess and a portion of the first piece of releasably cooperating material is secured in the recess, the method further comprising
moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly.

13. The method of claim 1 wherein the vibratory separator is a shale shaker for processing drilling fluid with solids entrained therein.

14. The method of claim 11 wherein the first screen assembly has a first recess in an end thereof, the second screen assembly has a second recess in an end thereof, and a connector is releasably disposable with a first portion thereof in the first recess and a second portion thereof in the second recess, the method further comprising
inserting the first portion of the connector into the first recess and the second portion of the connector into the second recess.

15. The method of claim 14 wherein at least a part of the connector is held loosely in one or both of the first recess and the second recess permitting freedom of movement of the first screen assembly with respect to the second screen assembly.

16. A method for manipulating a first screen assembly and a second screen assembly with respect to a screen assembly holding apparatus of a vibratory separator into or onto which the screen assemblies are mountable, the method comprising
positioning at least a portion of a first screen assembly with respect to screen assembly holding apparatus of a vibratory separator,
connecting a second screen assembly to the first screen assembly with releasably cooperating material on each screen assembly,
moving the first screen assembly and the second screen assembly together with respect to the screen assembly holding apparatus,
wherein the first screen assembly has a first recess and the releasably cooperating material includes a first piece of releasably cooperating material with part thereof held within the first recess and a second piece of releasably cooperating material on the second screen assembly located for engaging the first piece of releasably cooperating material, the method further comprising
moving the first screen assembly against the second screen assembly to engage the first piece of releasably cooperating material with the second piece of releasably cooperating material so that the first recess accommodates the two pieces of releasably cooperating material thereby permitting the first screen assembly to contactingly abut the second screen assembly, and
wherein the vibratory separator is a shale shaker for processing drilling fluid with solids entrained therein.

17. A method for manipulating a first screen assembly and a second screen assembly with respect to a screen assembly holding apparatus of a vibratory separator into or onto which the screen assemblies are mountable, the method comprising
positioning at least a portion of a first screen assembly with respect to screen assembly holding apparatus of a vibratory separator, the first screen assembly having a first recess and the second screen assembly having a second recess,
connecting a second screen assembly to the first screen assembly with a connector, the connector having a first portion in the first recess and a second portion in the second recess, and
moving the first screen assembly and the second screen assembly together with respect to the screen assembly holding apparatus.

18. The method of claim 16 wherein at least a part of the connector is held loosely in one or both of the first recess and the second recess permitting freedom of movement of the first screen assembly with respect to the second screen assembly.

19. A pair of connected screen assemblies for use with a vibratory separator, the pair including
a first screen assembly,
a second screen assembly,
the first screen assembly having a first amount of releasably cooperating material secured thereon,
the second screen assembly having a second amount of releasably cooperating material secured thereon, and
the first amount of releasably cooperating material sufficiently engaging the second amount of releasably cooperating material so that pulling on one of the first or second screen assemblies correspondingly moves the other screen assembly.

20. A pair of connected screen assemblies for use with a vibratory separator, the pair including
a first screen assembly,
a second screen assembly,
the first screen assembly having a first recess,
the second screen assembly having a second recess,
a connector with a first portion in the first recess and a second portion in the second recess, and
the connector releasably connecting the two screen assemblies so that pulling on one of the first or second screen assemblies correspondingly moves the other screen assembly.
